(19) United States
(12) Patent Application Publication
(10) Pub. No.: US 2024/0200937 A1
(43) Pub. Date: Jun. 20, 2024

(54) OPTICAL TILT SENSOR

(71) Applicant: ams Sensors Germany GmbH, Jena (DE)

(72) Inventor: Stephan MALKMUS, Eindhoven (NL)

(21) Appl. No.: 18/287,799

(22) PCT Filed: Apr. 21, 2022
(86) PCT No.: PCT/EP2022/060630

§ 371 Date: Oct. 20, 2023

(30) Foreign Application Priority Data
Apr. 23, 2021 (GB) 2105837.5

(51) Int. Cl. G01B 11/26; G05D 3/12

(52) U.S. Cl. CPC G01B 11/26; G05D 3/12

(57) ABSTRACT

An optical tilt measurement apparatus includes an optical tilt sensor for use in sensing a tilt angle of a flat reflective surface around a pivot axis. The optical tilt sensor includes an optical emitter arrangement for emitting at least three beams of light so that each emitted beam of light is incident on, and reflected from, the flat reflective surface to form a corresponding reflected beam of light. The optical tilt sensor also includes an image sensor having a sensor area for detecting an intensity distribution of each of the reflected beams of light and outputting one or more signals representative of the detected intensity distribution of each of the reflected beams of light. The at least three emitted beams of light are emitted along at least three corresponding different emission paths. Each emission path extends from a corresponding emission point along a different corresponding emission direction.

### FIELD

The present disclosure relates to an optical tilt sensor for use in sensing a tilt angle of a flat reflective surface around one or two different pivot axes, an optical tilt measurement apparatus for use in measuring a tilt angle of a flat reflective surface, an optical tilt control system for use in controlling a tilt angle of a flat reflective surface, and associated optical tilt measurement methods for use in sensing a tilt angle of a flat reflective surface around one or two different pivot axes, for use in measuring a tilt angle of a flat reflective surface, for use in controlling a tilt angle of a flat reflective surface, and for use in orienting first and second objects relative to one another.

### BACKGROUND

Optical tilt sensors are known for measuring the tilt and/or displacement of a flat reflective surface which rely upon the reflection of a beam of light from the flat reflective surface and the detection of the reflected beam of light on multiple photodetectors or on different sensor areas of the same multi-area optical sensor.

Optical tilt sensors are also known for measuring the tilt of a flat reflective surface which rely upon the reflection of a beam of light from the flat reflective surface, the use of a diffractive optical element to diffract the reflected beam of light to form a diffracted beam of light with a diffraction efficiency which depends on the tilt of the flat reflective surface, the use of a photodetector to detect the diffracted beam of light, and the calculation of the tilt of the flat reflective surface from an output signal of the photodetector.

However, such known optical sensors require calibration before the tilt and/or displacement of the flat reflective surface can be determined from the output signals generated by the one or more different photodetectors or by the different sensor areas of the same multi-area optical sensor.

### SUMMARY

### Optical Tilt Sensor

According to an aspect of the present disclosure there is provided an optical tilt sensor for use in sensing a tilt angle of a flat reflective surface around a pivot axis, the optical tilt sensor comprising:

an optical emitter arrangement for emitting at least three beams of light so that each emitted beam of light is incident on, and reflected from, the flat reflective surface to form a corresponding reflected beam of light; and an image sensor having a sensor area for detecting an intensity distribution of each of the reflected beams of light and outputting one or more signals representative of the detected intensity distribution of each of the reflected beams of light, wherein the at least three emitted beams of light are emitted along at least three corresponding different emission paths, each emission path extending from a corresponding emission point along a corresponding different emission direction, wherein each emission direction has a different known orientation relative to an orientation of the sensor area of the image sensor, and wherein each emission point has a known spatial relationship relative to each of the other emission points.

In use, the optical tilt sensor may be arranged relative to the flat reflective surface so that each emission direction has a different known orientation relative to the pivot axis. For example, the optical tilt sensor may be arranged relative to the flat reflective surface so that each emission direction defines a corresponding known angle relative to the pivot axis.

Optionally, the flat reflective surface is planar or generally planar.

Optionally, the flat reflective surface constitutes a flat reflective area of a larger generally non-planar surface, wherein the flat reflective area is planar or generally planar.

Optionally, one of the at least three different emission paths and a normal to the sensor area define a plane of incidence.

Optionally, each of the other emission paths defines an angle relative to the plane of incidence of less than or equal to 10°, less than or equal to 5°, less than or equal to 2°, or less than or equal to 1° or each of the other emission paths lies in, or lies substantially in, the plane of incidence.

In use, the optical tilt sensor may be arranged relative to the flat reflective surface so that the orientation of each of the different emission directions is known relative to the pivot axis. For example, the optical tilt sensor may be arranged relative to the flat reflective surface so that a normal to the plane of incidence defines an angle relative to the pivot axis of less than or equal to 10°, less than or equal to 5°, less than or equal to 2°, or less than or equal to 1°. The optical tilt sensor may be arranged relative to the flat reflective surface so that the plane of incidence is perpendicular, or substantially perpendicular to the pivot axis. Such an optical tilt sensor may be used in an optical tilt measurement apparatus for measuring an absolute value of the tilt angle of the flat reflective surface around the pivot axis, even where the distance from the optical tilt sensor to the flat reflective surface is unknown (or is at least not precisely known), even where the distance from the optical tilt sensor to the pivot axis is unknown (or is at least not precisely known), and without any need to calibrate the optical tilt sensor. From the following description, one of ordinary skill in the art will understand that the accuracy with which an optical tilt measurement apparatus including the optical tilt sensor may be used to measure an absolute value of the tilt angle of the flat reflective surface may depend at least in part on the accuracy with which the orientation of the different emission directions are known relative to the sensor area of the image sensor, the accuracy with which the spatial relationship between the emission points is known, the accuracy with which the orientation of the different emission directions are known relative to the pivot axis, the flatness of the reflective surface, and the resolution of the image sensor.

Such an optical tilt sensor may be used in an optical tilt measurement apparatus for measuring a change in the tilt angle of the flat reflective surface around the pivot axis with an accuracy which is higher than the accuracy with which the optical tilt measurement apparatus may be used to measure an absolute value of the tilt angle of the flat reflective surface around the pivot axis.

Optionally, each of the emission directions defines a corresponding known angle relative to a normal to the sensor area of the image sensor.

Optionally, the image sensor comprises at least one of a 1D image sensor, a linear photodetector, a 1D optical sensor array, a 1D photodetector array such as a 1D photodiode array, a 1D CCD image sensor or a 1D CMOS image sensor.

Optionally, an angular separation between the emission directions of one or more pairs of adjacent emitted beams is different, for example significantly different, to an angular separation between the emission directions of the other pairs of adjacent emitted beams. Such an arrangement of the emission directions may assist with the identification of the intensity distributions on the sensor area of the image sensor corresponding to each of the emitted beams.

Optionally, the optical emitter arrangement is configured to emit first, second, third, fourth, fifth, sixth and seventh beams of light along first, second, third, fourth, fifth, sixth and seventh different corresponding emission directions, wherein an angular separation between the third and fourth emitted beams is different to an angular separation between the first and second emitted beams, an angular separation between the second and third emitted beams, an angular separation between the fourth and fifth emitted beams, an angular separation between the fifth and sixth emitted beams, and an angular separation between the sixth and seventh emitted beams.

Optionally, two or more of the emission points are the same.

Optionally, all of the emission points are the same.

Optionally, two or more of the emission points are different.

Optionally, all of the emission points are different.

Optionally, a distance between the emission points of one or more pairs of adjacent emitted beams is different to a distance between the emission points of the other pairs of adjacent emitted beams. Such an arrangement of the emission points may assist with the identification of the intensity distributions on the sensor area of the image sensor corresponding to each of the emitted beams.

Optionally, the image sensor and the optical emitter arrangement have a fixed spatial relationship relative to one another.

Optionally, the optical emitter arrangement is surface-emitting.

Optionally, the optical tilt sensor comprises a base member, wherein the optical emitter arrangement and the image sensor are both mounted on the same surface of the base member.

### Timing of Emission

Optionally, the optical emitter arrangement is configured to emit the at least three beams of light simultaneously.

Optionally, the optical emitter arrangement is configured to emit the at least three beams of light sequentially.

Optionally, the optical emitter arrangement is configured to emit each of the at least three beams of light for the duration of a corresponding emission period.

Optionally, the different emission periods at least partially overlap in time.

### Optical Emitter

Optionally, the optical emitter arrangement comprises an optical emitter.

Optionally, the optical emitter comprises an LED or a laser such as a laser diode, for example a VCSEL.

### Spatial Filter

Optionally, the optical emitter arrangement comprises a spatial filter for spatially filtering light emitted from the optical emitter so as to at least partially define the at least three emitted beams of light.

Optionally, the image sensor and the spatial filter have a fixed spatial relationship relative to one another.

Optionally, a normal to an output surface of the spatial filter and the normal to the sensor area of the image sensor have a known spatial relationship relative to one another.

Optionally, a normal to an output surface of the spatial filter and the normal to the sensor area of the image sensor are parallel.

Optionally, the spatial filter defines one or more apertures.

Optionally, one or more of the apertures comprises a pinhole.

Optionally, one or more of the apertures comprises a slit.

Optionally, the optical emitter arrangement comprises a focussing element such as a lens configured to focus light emitted from the optical emitter onto one or more of the apertures.

Optionally, one or more of the apertures is configured so as to minimise diffraction of light transmitted through the aperture, for example wherein each aperture has a dimension which is greater than a wavelength of the light, at least 10 times greater than a wavelength of the light, or at least 100 times greater than a wavelength of the light.

Optionally, one or more of the apertures is configured to diffract light transmitted through the aperture, for example wherein each aperture has a dimension which is less than 100 times a wavelength of the light, less than 10 times a wavelength of the light, or less than or equal to a wavelength of the light.

Optionally, the spatial filter defines at least three apertures, wherein each aperture has a known position and orientation relative to each of the other apertures, and wherein each aperture is configured to transmit light emitted by the optical emitter along a corresponding one of the emission paths. Optionally, each aperture is located on a surface of the spatial filter. Optionally, the spatial filter comprises a transparent substrate having a patterned opaque coating on an output surface of the transparent substrate, wherein each of the at least three apertures is defined by a corresponding aperture in the opaque coating.

Optionally, the spatial filter defines at least three input apertures and an output aperture. Optionally, each input aperture has a known position and orientation relative to each of the other input apertures and the output aperture. Optionally, each input aperture is configured to receive light from the optical emitter. Optionally, the output aperture is configured to transmit light received from each input aperture along a corresponding one of the emission paths. Optionally, each input aperture is located on an input surface of the spatial filter. Optionally, the output aperture is located on an output surface of the spatial filter. Optionally, each of the input apertures is offset relative to a normal to the output surface of the spatial filter which extends through the output aperture. Optionally, the spatial filter comprises a transparent substrate having a patterned opaque coating on an input surface of the substrate and a patterned opaque coating on an output surface of the substrate, wherein each of the at least three input apertures is defined by a corresponding aperture in the opaque coating on the input surface of the substrate and the output aperture is defined by a corresponding aperture in the opaque coating on the output surface of the substrate. Optionally, the optical emitter arrangement comprises a focussing element such as a lens configured to focus light emitted from the optical emitter onto the output aperture.

Optionally, the spatial filter defines an input aperture and at least three output apertures. Optionally, each output aperture has a known position and orientation relative to each of the other output apertures and the input aperture. Optionally, the input aperture is configured to receive light from the optical emitter. Optionally, each output aperture is configured to transmit light received from the input aperture along a corresponding one of the emission paths. Optionally, the input aperture is located on an input surface of the spatial filter. Optionally, each output aperture is located on an output surface of the spatial filter. Optionally, each of the output apertures is offset relative to a normal to the input surface of the spatial filter which extends through the input aperture. Optionally, the spatial filter comprises a transparent substrate having a patterned opaque coating on an input surface of the substrate and a patterned opaque coating on an output surface of the substrate, wherein the input aperture is defined by an aperture in the opaque coating on the input surface of the substrate and each of the at least three output apertures is defined by a corresponding aperture in the opaque coating on the output surface of the substrate. Optionally, the optical emitter arrangement comprises a focussing element such as a lens configured to focus light emitted from the optical emitter onto the input aperture.

Optionally, the transparent substrate comprises a glass.

Optionally, each of the opaque coatings comprises a metal such as chrome.

Optionally, the spatial filter comprises one or more optical micro-structures or micro-optical components and wherein each of the one or more optical micro-structures or micro-optical components is arranged, for example formed, on or over a corresponding aperture defined by the spatial filter.

Optionally, each of the one or more optical micro-structures or micro-optical components is arranged, for example formed, on or over a corresponding input aperture defined by the spatial filter.

Optionally, each of the one or more optical micro-structures or micro-optical components is arranged, for example formed, on or over a corresponding output aperture defined by the spatial filter.

Optionally, each of the one or more optical micro-structures or micro-optical components is configured to shape the light leaving the spatial filter so that each reflected beam of light projects a corresponding intensity distribution on the sensor area of the image sensor of a desired shape.

Optionally, each of the one or more optical micro-structures or micro-optical components comprises a micro-lens. The use of a micro-lens aligned with an input aperture of the spatial filter may improve the efficiency with which light from the optical emitter enters the transparent substrate. The use of a micro-lens aligned with an output aperture of the spatial filter may improve the efficiency with which light from the optical emitter leaves the transparent substrate. The use of a micro-lens aligned with an output aperture of the spatial filter may reduce the divergence and/or collimate the corresponding emitted beam.

Optionally, each of the one or more optical micro-structures or micro-optical components comprises a micro-prism. The use of a micro-prism aligned with an input aperture of the spatial filter may improve the efficiency with which light from the optical emitter enters the transparent substrate. The use of a micro-prism aligned with an output aperture of the spatial filter may improve the efficiency with which light from the optical emitter leaves the transparent substrate.

Re-Direction of Light Emitted from the Optical Emitter

Optionally, the optical emitter arrangement comprises a transparent component such as a transparent substrate or a prism which is configured to refract light emitted from the optical emitter so as to re-direct the light emitted from the optical emitter. Optionally, the transparent component has an edge defining a surface which is oriented at an acute angle relative to an output surface of the transparent component. Where the optical emitter is a surface-emitting optical emitter, such a transparent component may serve to re-direct light emitted by the optical emitter whist also allowing a light-emitting surface of the optical emitter to be aligned parallel to the output surface of the transparent component. Optionally, the optical emitter arrangement comprises a mirror which is configured to reflect light emitted from the optical emitter so as to re-direct the light emitted from the optical emitter.

### Optical Emitter and Diffractive Optical Element (DOE)

Optionally, the optical emitter arrangement comprises a diffractive optical element for diffracting an initial beam of light emitted from the optical emitter so as to define the at least three emitted beams of light.

Optionally, the diffractive optical element is configured to diffract the initial beam of light emitted from the optical emitter so as to define structured light which includes the at least three emitted beams of light.

Optionally, the structured light has a transverse intensity distribution which is transverse to a direction of propagation of the structured light and which is defined by a configuration of the diffractive optical element.

Optionally, the transverse intensity distribution defines a 1D or 2D grating, a 1D or 2D grid or a 1D or 2D array of spots.

### Optical Emitter and Reconfigurable Beam Generator

Optionally, the optical emitter arrangement comprises a reconfigurable, dynamic or programmable beam generator for converting an initial beam of light emitted from the optical emitter so as to define the at least three emitted beams of light.

Optionally, the beam generator comprises a spatial light modulator (SLM) such as a SLM modulator comprising, or formed from, a liquid crystal material, or a digital micromirror device (DMD).

Optical Emitter with Patterned Opaque Coating Formed on Light Emitting Surface of Optical Emitter

Optionally, the optical emitter comprises a patterned opaque coating formed directly on a light emitting surface of the optical emitter so as to define at least three light emitting apertures, wherein each light emitting aperture has a known spatial relationship relative to each of the other light emitting apertures.

Optionally, the optical emitter arrangement comprises a spatial filter for spatially filtering light emitted from each light emitting aperture of the optical emitter. The spatial filter may define one or more apertures for spatially filtering light emitted from each light emitting aperture of the optical emitter.

Optionally, the optical emitter arrangement comprises a focussing element such as a lens configured to focus light emitted from each of the light emitting apertures and wherein the focussing element has a known spatial relationship relative to each of the light emitting apertures so as to define the at least three emitted beams of light.

### Multiple Optical Emitters

Optionally, the optical emitter arrangement comprises at least three optical emitters, wherein the at least three optical emitters have a known position and orientation relative to one another.

Optionally, each optical emitter comprises an LED.

Optionally, each optical emitter comprises a laser such as a laser diode, for example a VCSEL.

Optionally, the optical emitter arrangement comprises an LED array such as a pixelated LED.

Optionally, the optical emitter arrangement comprises a laser array, such as a laser diode array, for example a VCSEL array.

Optionally, each optical emitter is controllable independently of each of the other optical emitters.

Optionally, the optical emitter arrangement comprises a focussing element such as a lens having a known spatial relationship relative to the at least three optical emitters, wherein the lens directs, focusses and/or collimates light emitted by each optical emitter of the at least three optical emitters so as to define the at least three emitted beams of light.

Optionally, the optical emitter arrangement comprises at least three micro-lenses, wherein each micro-lens has a known configuration and a known position and orientation relative to a corresponding optical emitter of the at least three optical emitters so as to define the at least three emitted beams of light.

Optionally, the optical emitter arrangement comprises a spatial filter having a known configuration and a known position and orientation relative to the at least three optical emitters so as to spatially filter light emitted by each optical emitter of the at least three optical emitters so as to define the at least three emitted beams of light.

Optionally, the spatial filter defines an aperture, wherein the aperture has a known position and orientation relative to the at least three optical emitters, and wherein the aperture is configured to transmit light emitted by the at least three optical emitters along the at least three emission directions.

Optionally, the at least three optical emitters are offset relative to a normal to the output surface of the spatial filter which extends through the aperture.

Optionally, the spatial filter comprises a transparent substrate having a patterned opaque coating on a surface, for example an output surface, of the transparent substrate and wherein the aperture is defined by an aperture in the opaque coating.

### Optical Tilt Measurement Apparatus

According to an aspect of the present disclosure there is provided an optical tilt measurement apparatus for use in measuring a tilt angle of a flat reflective surface around a pivot axis, the optical tilt measurement apparatus comprising:
the optical tilt sensor; and
a processing resource configured to receive the one or more output signals from the image sensor and to determine the tilt angle of the flat reflective surface based at least in part on the one or more received output signals, the different known orientations of the different emission directions relative to the orientation of the sensor area of the image sensor, and the known relative spatial relationship between the emission points.

In use, the optical tilt sensor may be arranged relative to the flat reflective surface so that each emission direction has a different known orientation relative to the pivot axis and the processing resource may be configured to determine the tilt angle of the flat reflective surface based at least in part on the different known orientation of each emission direction relative to the pivot axis. For example, the optical tilt sensor may be arranged relative to the flat reflective surface so that each emission direction defines a corresponding known angle relative to the pivot axis and the processing resource may be configured to determine the tilt angle of the flat reflective surface around the pivot axis based at least in part on the different known angle of each emission direction relative to the pivot axis.

In use, the optical tilt sensor may be arranged relative to the flat reflective surface so that the plane of incidence has a known orientation relative to the pivot axis and the processing resource may be configured to determine the tilt angle of the flat reflective surface based at least in part on the known orientation of the plane of incidence relative to the pivot axis.

The processing resource may be configured to:
determine, from the one or more received output signals, a position of each of at least three intensity peaks on the sensor area of the image sensor, each intensity peak corresponding to the peak intensity of a corresponding one of the reflected beams of light when incident on the sensor area of the image sensor;
determine a spacing of a first pair of the at least three intensity peaks on the sensor area of the image sensor;
determine a spacing of a second pair of the at least three intensity peaks on the sensor area of the image sensor; and
determine the tilt angle of the flat reflective surface around the pivot axis based at least in part on the determined spacing of the first pair of intensity peaks and the determined spacing of the second pair of intensity peaks.

Optical Tilt Control System for Use in Controlling a Tilt Angle of a Flat Reflective Surface Around a Pivot Axis

According to an aspect of the present disclosure there is provided an optical tilt control system for use in controlling a tilt angle of a flat reflective surface, and any one or more objects or assemblies connected to the flat reflective surface, around a pivot axis, the optical tilt control system comprising:
the optical tilt measurement apparatus; and
a tilt actuator for adjusting the tilt angle of the flat reflective surface, and any one or more objects or assemblies connected to the flat reflective surface, around the pivot axis,
wherein the processing resource is configured to control the tilt actuator so as to control the tilt angle of the flat reflective surface, and any one or more objects or assemblies connected to the flat reflective surface, based on the determined tilt angle of the flat reflective surface.

Method for Use in Sensing a Tilt Angle

According to an aspect of the present disclosure there is provided a method for use in sensing a tilt angle of a flat reflective surface around a pivot axis, the method comprising:
emitting at least three beams of light so that each emitted beam of light is incident on, and reflected from, the flat reflective surface to form a corresponding reflected beam of light; and
detecting an intensity distribution of each of the reflected beams of light on a sensor area of an image sensor and outputting one or more signals representative of the detected intensity distribution of each of the reflected beams of light,
wherein the at least three beams of light are emitted along at least three corresponding different emission paths, each emission path extending from a corresponding emission point along a different corresponding emission direction, and
wherein each emission direction has a different known orientation relative to an orientation of the sensor area of the image sensor and each emission point has a known spatial relationship relative to each of the other emission points.

Optionally, the method comprises arranging the optical tilt sensor relative to the flat reflective surface so that each emission direction has a different known orientation relative to the pivot axis.

Optionally, the method comprises arranging the optical tilt sensor relative to the flat reflective surface so that each emission direction defines a corresponding known angle relative to the pivot axis.

Optionally, the at least three different emission paths define a plane of incidence.

Optionally, the method comprises arranging the optical tilt sensor relative to the flat reflective surface so that the plane of incidence has a known orientation relative to the pivot axis.

Optionally, the method comprises arranging the optical tilt sensor relative to the flat reflective surface so that a normal to the plane of incidence defines an angle relative to the pivot axis of less than or equal to 10°, less than or equal to 5°, less than or equal to 2°, or less than or equal to 1°.

Optionally, the method comprises arranging the optical tilt sensor relative to the flat reflective surface so that the plane of incidence is perpendicular, or substantially perpendicular to the pivot axis.

Optionally, the method comprises arranging the at least three emitted beams of light relative to the flat reflective surface so that the intensity distributions of the reflected beams of light on the sensor area of the image sensor are distinct, non-contiguous and/or non-overlapping.

Optionally, the method comprises arranging the at least three emitted beams of light relative to the flat reflective surface so that two or more of the intensity distributions of the reflected beams of light on the sensor area of the image sensor are partially overlapping.

Optionally, the method comprises arranging the at least three emitted beams of light relative to the flat reflective surface so that each of the intensity distributions of the reflected beams of light on the sensor area of the image sensor has a corresponding peak or centroid and wherein the peaks or centroids of the intensity distributions of the reflected beams of light are located at different positions on the sensor area of the image sensor.

Method for Use in Measuring and/or Controlling a Tilt Angle of a Flat Reflective Surface Around a Pivot Axis

According to an aspect of the present disclosure there is provided a method for use in measuring a tilt angle of a flat reflective surface around a pivot axis, the method comprising the method for use in sensing the tilt angle of the flat reflective surface around the pivot axis as described above and the method further comprising determining the tilt angle of the flat reflective surface around the pivot axis based at least in part on the one or more output signals, the different known orientations of the different emission directions relative to the orientation of the sensor area of the image sensor, the known relative spatial relationship between the emission points, and the known orientation of each emission direction relative to the pivot axis.

Optionally, the method comprises:
determining, from the one or more received output signals, a position of each of at least three intensity peaks on the sensor area of the image sensor, each intensity peak corresponding to the peak intensity of a corresponding one of the reflected beams of light when incident on the sensor area of the image sensor;
determining a spacing of a first pair of the at least three intensity peaks on the sensor area of the image sensor;
determining a spacing of a second pair of the at least three intensity peaks on the sensor area of the image sensor; and
determining the tilt angle of the flat reflective surface around the pivot axis based at least in part on the determined spacing of the first pair of intensity peaks and the determined spacing of the second pair of intensity peaks.

According to an aspect of the present disclosure there is provided a method for use in controlling a tilt angle of a flat reflective surface, and any one or more objects or assemblies connected to the flat reflective surface, around a pivot axis, the method comprising:

the method for use in measuring the tilt angle of the flat reflective surface around the pivot axis as described above and the method further comprising controlling the tilt angle of the flat reflective surface, and any one or more objects or assemblies connected to the flat reflective surface, based on the determined tilt angle of the flat reflective surface.

According to an aspect of the present disclosure there is provided a method for use in measuring a tilt angle of a flat reflective surface around a pivot axis, the method comprising the method for use in sensing the tilt angle of the flat reflective surface around the pivot axis as described above and the method further comprising:
determining a first tilt angle of the flat reflective surface around the pivot axis based at least in part on the one or more output signals generated according to the method as described above when the flat reflective surface is tilted around the pivot axis at the first tilt angle;
determining a second tilt angle of the flat reflective surface around the pivot axis based at least in part on the one or more output signals generated according to the method as described above when the flat reflective surface is tilted around the pivot axis at the second tilt angle; and
determining a change between the first and second tilt angles of the flat reflective surface around the pivot axis such as a difference between the first and second tilt angles, a percentage change between the first and second tilt angles, or a ratio of the first and second tilt angles.

The first and second tilt angles may correspond to the tilt angle of the flat reflective surface around the pivot axis at first and second instants in time respectively.

According to an aspect of the present disclosure there is provided a method for use in controlling a tilt angle of a flat reflective surface, and any one or more objects or assemblies connected to the flat reflective surface, around a pivot axis, the method comprising:
the method for use in measuring the tilt angle of the flat reflective surface around the pivot axis as described above and the method further comprising controlling the tilt angle of the flat reflective surface, and any one or more objects or assemblies connected to the flat reflective surface, based on the determined change between the first and second tilt angles of the flat reflective surface around the pivot axis.

### Method for Orienting First and Second Objects Relative to One Another

According to an aspect of the present disclosure there is provided a method for use in orienting first and second objects relative to one another, the method comprising:
mounting the optical tilt sensor as described above on a surface of a base member;
mounting the first object on the surface of the base member;
arranging the second object relative to the optical tilt sensor so that each emitted beam of light is incident on, and reflected from, a flat reflective surface of the second object to form the corresponding reflected beam of light, so that the sensor area of the image sensor detects an intensity distribution of each of the reflected beams of light and outputs one or more signals representative of the detected intensity distribution of each of the reflected beams of light, and so that each emission direction has a different known orientation relative to the pivot axis;
determining a tilt angle of the flat reflective surface of the second object around the pivot axis based at least in part on the one or more output signals, the different known orientations of the different emission directions relative to the orientation of the sensor area of the image sensor, the known relative spatial relationship between the emission points, and the known orientation of each emission direction relative to the pivot axis; and
controlling the relative orientation of the first and second objects according to the determined tilt angle of the flat reflective surface of the second object.

Optionally, the method comprises determining the tilt angle of the flat reflective surface based at least in part on a spacing of a first pair of intensity peaks corresponding to a first pair of the reflected beams of light on the sensor area of the image sensor and a spacing of a second pair of intensity peaks corresponding to a second pair of the reflected beams of light on the sensor area of the image sensor.

The first object may comprise a first component such as a first optical component or a first assembly such as a first assembly of optical components.

The second object may comprise a second component such as a second optical component or a second assembly such as a second assembly of optical components.

### 3D Optical Tilt Sensor

According to an aspect of the present disclosure there is provided an optical tilt sensor for use in sensing a tilt angle of a flat reflective surface around a pivot axis and a further tilt angle of the flat reflective surface around a further pivot axis, the optical tilt sensor comprising the optical tilt sensor for use in sensing the tilt angle of the flat reflective surface around the pivot axis as described above,
wherein the optical emitter arrangement is configured to emit at least three further beams of light so that each further emitted beam of light is incident on, and reflected from, the flat reflective surface to form a corresponding further reflected beam of light,
wherein the sensor area of the image sensor is configured to detect an intensity distribution of each of the further reflected beams of light and to output one or more further signals representative of the detected intensity distribution of each of the further reflected beams of light,
wherein the at least three further beams of light are emitted along at least three corresponding different further emission paths, each further emission path extending from a corresponding further emission point along a different corresponding further emission direction, and
wherein each further emission direction has a different known orientation relative to an orientation of the sensor area of the image sensor, and each further emission point has a known spatial relationship relative to each of the other further emission points.

The further pivot axis may be perpendicular to the pivot axis.

The pivot axis and the further pivot axis may be intersecting. The pivot axis and the further pivot axis may intersect one another at a pivot point.

The pivot axis and the further pivot axis may be non-intersecting.

In use, the optical tilt sensor may be arranged relative to the flat reflective surface so that each further emission direction has a different known orientation relative to the pivot axis. For example, the optical tilt sensor may be arranged relative to the flat reflective surface so that each further emission direction defines a corresponding known angle relative to the pivot axis.

Optionally, one of the at least three different further emission paths and a normal to the sensor area define a further plane of incidence.

Optionally, each of the other further emission paths defines an angle relative to the further plane of incidence of less than or equal to 10°, less than or equal to 5°, less than or equal to 2°, or less than or equal to 1° or each of the other further emission paths lies in, or lies substantially in, the further plane of incidence.

In use, the optical tilt sensor may be arranged relative to the flat reflective surface so that the orientation of each of the different further emission directions are known relative to the further pivot axis around which the flat reflective surface tilts. For example, the optical tilt sensor may be arranged relative to the flat reflective surface so that a normal to the further plane of incidence defines an angle relative to the further pivot axis of less than or equal to 10°, less than or equal to 5°, less than or equal to 2°, or less than or equal to 1°. The optical tilt sensor may be arranged relative to the flat reflective surface so that the further plane of incidence is perpendicular, or substantially perpendicular to the further pivot axis. Such an optical tilt sensor may be used in an optical tilt measurement apparatus for measuring an absolute value of a further tilt angle of the flat reflective surface around the further pivot axis in addition to an absolute value of the tilt angle of the flat reflective surface around the pivot axis, even where the distance from the optical tilt sensor to the flat reflective surface is unknown (or is at least not precisely known), the distances from the optical tilt sensor to the pivot axis and the further pivot axis are unknown (or are at least not precisely known), and without any need to calibrate the optical tilt sensor. As such, it should be understood that such an optical tilt sensor may be used in an optical tilt measurement apparatus for measuring the 3D tilt of the flat reflective surface, even where the distance from the optical tilt sensor to the flat reflective surface is unknown (or is at least not precisely known), the distances from the optical tilt sensor to the pivot axis and the further pivot axis are unknown (or are at least not precisely known), and without any need to calibrate the optical tilt sensor. From the following description, one of ordinary skill in the art will understand that the accuracy with which an optical tilt measurement apparatus including the optical tilt sensor may be used to measure an absolute value of the tilt angle and of the further tilt angle of the flat reflective surface may depend at least in part on the accuracy with which the orientation of the different emission directions and the different further emission directions are known relative to the sensor area of the image sensor, the accuracy with which the spatial relationship between the emission points and the further emission points is known, the accuracy with which the orientation of the different emission directions are known relative to the pivot axis, the accuracy with which the orientation of the different further emission directions are known relative to the further pivot axis, the flatness of the reflective surface, and the resolution of the image sensor.

Such an optical tilt sensor may be used in an optical tilt measurement apparatus for measuring a change in the tilt angle of the flat reflective surface around the pivot axis and a change in the further tilt angle of the flat reflective surface around the further pivot axis with an accuracy which is higher than the accuracy with which the optical tilt measurement apparatus may be used to measure an absolute value of the tilt angle of the flat reflective surface around the pivot axis and an absolute value of the further tilt angle of the flat reflective surface around the further pivot axis.

Optionally, the image sensor comprises at least one of a 2D image sensor, a 2D optical sensor array, a 2D photodetector array such as a 2D photodiode array, a 2D CCD image sensor or a 2D CMOS image sensor.

### 3D Optical Tilt Measurement Apparatus

According to an aspect of the present disclosure there is provided an optical tilt measurement apparatus for use in measuring a tilt angle of a flat reflective surface around a pivot axis and a further tilt angle of the flat reflective surface around a further pivot axis, the optical tilt measurement apparatus comprising:
the optical tilt sensor for use in measuring a tilt angle of a flat reflective surface around a pivot axis and a further tilt angle of the flat reflective surface around a further pivot axis; and
a processing resource configured to receive the one or more output signals and the one or more further output signals from the image sensor and to determine the tilt angle and the further tilt angle of the flat reflective surface based at least in part on the one or more received output signals, the one or more further output signals, the different known orientations of the different emission directions relative to the orientation of the sensor area of the image sensor, the different known orientations of the different further emission directions relative to the orientation of the sensor area of the image sensor, the known relative spatial relationship between the emission points, and the known relative spatial relationship between the further emission points.

In use, the optical tilt sensor may be arranged relative to the flat reflective surface so that each emission direction and each further emission direction has a different known orientation relative to the pivot axis and the processing resource may be configured to determine the tilt angle of the flat reflective surface based at least in part on the different known orientation of each emission direction and the different known orientation of each further emission direction relative to the pivot axis. For example, the optical tilt sensor may be arranged relative to the flat reflective surface so that each emission direction and each further emission direction defines a corresponding known angle relative to the pivot axis and the processing resource may be configured to determine the tilt angle of the flat reflective surface based at least in part on the different known angle of each emission direction and the different known angle of each further emission direction relative to the pivot axis.

In use, the optical tilt sensor may be arranged relative to the flat reflective surface so that the plane of incidence has a known orientation relative to the pivot axis and the further plane of incidence has a known orientation relative to the further pivot axis, and the processing resource may be configured to determine the tilt angle of the flat reflective surface based at least in part on the known orientation of the plane of incidence relative to the pivot axis and the further tilt angle of the flat reflective surface based at least in part on the known orientation of the further plane of incidence relative to the further pivot axis.

Optionally, the processing resource is configured to determine the tilt angle of the flat reflective surface based at least in part on a spacing of a first pair of intensity peaks corresponding to a first pair of the reflected beams of light on the sensor area of the image sensor and a spacing of a second pair of intensity peaks corresponding to a second pair of the reflected beams of light on the sensor area of the image sensor.

Optionally, the processing resource is configured to determine the further tilt angle of the flat reflective surface based at least in part on a spacing of a first pair of further intensity peaks corresponding to a first pair of the further reflected beams of light on the sensor area of the image sensor and a spacing of a second pair of further intensity peaks corresponding to a second pair of the further reflected beams of light on the sensor area of the image sensor.

### 3D Optical Tilt Control System

According to an aspect of the present disclosure there is provided an optical tilt control system for use in controlling a tilt angle of a flat reflective surface, and any one or more objects or assemblies connected to the flat reflective surface, around a pivot axis and a further tilt angle of the flat reflective surface, and any one or more objects or assemblies connected to the flat reflective surface, around a further pivot axis, the optical tilt control system comprising:
the optical tilt measurement apparatus for use in measuring the tilt angle of the flat reflective surface around the pivot axis and the further tilt angle of the flat reflective surface around the further pivot axis; and
one or more tilt actuators for adjusting the tilt angle of the flat reflective surface, and any one or more objects or assemblies connected to the flat reflective surface, around the pivot axis and for adjusting the further tilt angle of the flat reflective surface, and any one or more objects or assemblies connected to the flat reflective surface, around the further pivot axis,
wherein the processing resource is configured to control the one or more tilt actuators so as to control the tilt angle of the flat reflective surface, and any one or more objects or assemblies connected to the flat reflective surface, based on the determined tilt angle of the flat reflective surface and so as to control the further tilt angle of the flat reflective surface, and any one or more objects or assemblies connected to the flat reflective surface, based on the determined further tilt angle of the flat reflective surface.

### 3D Tilt Sensing Method

According to an aspect of the present disclosure there is provided a method for use in sensing a tilt angle of a flat reflective surface around a pivot axis and a further tilt angle of the flat reflective surface around a further pivot axis, the method comprising the method for use in measuring a tilt angle of a flat reflective surface around a pivot axis and the method further comprising:
emitting at least three further beams of light so that each further emitted beam of light is incident on, and reflected from, the flat reflective surface to form a corresponding further reflected beam of light; and
detecting an intensity distribution of each of the further reflected beams of light and outputting one or more further signals representative of the detected intensity distribution of each of the further reflected beams of light,
wherein the at least three further emitted beams of light are emitted along at least three corresponding different further emission paths, each further emission path extending from a corresponding further emission point along a different corresponding further emission direction, and
wherein each further emission direction has a different known orientation relative to an orientation of the sensor area of the image sensor, each further emission point has a known spatial relationship relative to each of the other further emission points.

The further pivot axis may, for example, be perpendicular to the pivot axis.

Optionally, the method comprises arranging the optical tilt sensor relative to the flat reflective surface so that each further emission direction has a different known orientation relative to the further pivot axis.

Optionally, the method comprises arranging the optical tilt sensor relative to the flat reflective surface so that each further emission direction defines a corresponding known angle relative to the further pivot axis.

Optionally, one of the at least three different further emission paths and a normal to the sensor area define a further plane of incidence.

Optionally, each of the other further emission paths defines an angle relative to the further plane of incidence of less than or equal to 10°, less than or equal to 5°, less than or equal to 2°, or less than or equal to 1° or each of the other further emission paths lies in, or lies substantially in, the further plane of incidence.

Optionally, the method comprises arranging the optical tilt sensor relative to the flat reflective surface so that the further plane of incidence has a known orientation relative to the further pivot axis around which the flat reflective surface tilts.

Optionally, the method comprises arranging the optical tilt sensor relative to the flat reflective surface so that a normal to the further plane of incidence defines an angle relative to the further pivot axis of less than or equal to 10°, less than or equal to 5°, less than or equal to 2°, or less than or equal to 1°.

Optionally, the method comprises arranging the optical tilt sensor relative to the flat reflective surface so that the further plane of incidence is perpendicular, or substantially perpendicular to the further pivot axis.

Optionally, the method comprises arranging the at least three further emitted beams of light relative to the flat reflective surface so that the intensity distributions of the further reflected beams of light on the sensor area of the image sensor are distinct, non-contiguous and/or non-overlapping.

Optionally, the method comprises arranging the at least three further emitted beams of light relative to the flat reflective surface so that two or more of the intensity distributions of the further reflected beams of light on the sensor area of the image sensor are partially overlapping.

Optionally, the method comprises arranging the at least three further emitted beams of light relative to the flat reflective surface so that each of the intensity distributions of the further reflected beams of light on the sensor area of the image sensor has a corresponding peak or centroid and wherein the peaks or centroids of the intensity distributions of the further reflected beams of light are located at different positions on the sensor area of the image sensor.

Method for Use in Measuring and/or Controlling a Tilt Angle in 3D

According to an aspect of the present disclosure there is provided a method for use in measuring a tilt angle of a flat reflective surface around a pivot axis and a further tilt angle of the flat reflective surface around a further pivot axis, the method comprising the method for use in sensing the tilt angle of the flat reflective surface around the pivot axis and the further tilt angle of the flat reflective surface around the further pivot axis as described above, and the method further comprising determining the further tilt angle of the flat reflective surface around the further pivot axis based at least in part on the one or more further output signals, the different known orientations of the different further emission directions relative to the orientation of the sensor area of the image sensor, the known relative spatial relationship between the further emission points, and the known orientation of each further emission direction relative to the further pivot axis.

Optionally, the method comprises determining the further tilt angle of the flat reflective surface based at least in part on a spacing of a first pair of further intensity peaks corresponding to a first pair of the further reflected beams of light on the sensor area of the image sensor and a spacing of a second pair of further intensity peaks corresponding to a second pair of the further reflected beams of light on the sensor area of the image sensor.

According to an aspect of the present disclosure there is provided a method for use in controlling a tilt angle of a flat reflective surface, and any one or more objects or assemblies connected to the flat reflective surface, around a pivot axis and a further tilt angle of the flat reflective surface, and any one or more objects or assemblies connected to the flat reflective surface, around a further pivot axis, the method comprising:
the method for use in measuring the tilt angle of the flat reflective surface around the pivot axis and the further tilt angle of the flat reflective surface around the further pivot axis as described above, and the method further comprising controlling the tilt angle of the flat reflective surface, and any one or more objects or assemblies connected to the flat reflective surface, based on the determined tilt angle of the flat reflective surface and controlling the further tilt angle of the flat reflective surface, and any one or more objects or assemblies connected to the flat reflective surface, based on the determined further tilt angle of the flat reflective surface.

According to an aspect of the present disclosure there is provided a method for use in measuring a tilt angle of a flat reflective surface around a pivot axis and a further tilt angle of the flat reflective surface around a further pivot axis, the method comprising the method for use in sensing the tilt angle of the flat reflective surface around the pivot axis and the further tilt angle of the flat reflective surface around the further pivot axis as described above, and the method further comprising:
determining a first tilt angle of the flat reflective surface around the pivot axis based at least in part on the one or more output signals generated according to the method as described above when the flat reflective surface is tilted around the pivot axis at the first tilt angle;
determining a second tilt angle of the flat reflective surface around the pivot axis based at least in part on the one or more output signals generated according to the method as described above when the flat reflective surface is tilted around the pivot axis at the second tilt angle; and
determining a change between the first and second tilt angles of the flat reflective surface around the pivot axis such as a difference between the first and second tilt angles, a percentage change between the first and second tilt angles, or a ratio of the first and second tilt angles;
determining a first further tilt angle of the flat reflective surface around the further pivot axis based at least in part on the one or more output signals generated according to the method as described above when the flat reflective surface is tilted around the further pivot axis at the first further tilt angle;
determining a second further tilt angle of the flat reflective surface around the further pivot axis based at least in part on the one or more output signals generated according to the method as described above when the flat reflective surface is tilted around the further pivot axis at the second further tilt angle; and
determining a change between the first further and second further tilt angles of the flat reflective surface around the further pivot axis such as a difference between the first further and second further tilt angles, a percentage change between the first further and second further tilt angles, or a ratio of the first further and second further tilt angles.

The first and second tilt angles may correspond to the tilt angle of the flat reflective surface around the pivot axis at first and second instants in time respectively.

The first and second further tilt angles may correspond to the further tilt angle of the flat reflective surface around the further pivot axis at the first and second instants in time.

According to an aspect of the present disclosure there is provided a method for use in controlling a tilt angle of a flat reflective surface, and any one or more objects or assemblies connected to the flat reflective surface, around a pivot axis and a further tilt angle of the flat reflective surface, and any one or more objects or assemblies connected to the flat reflective surface, around a further pivot axis, the method comprising:
the method for use in measuring the tilt angle of the flat reflective surface around the pivot axis and the further tilt angle of the flat reflective surface around the further pivot axis as described above, and the method further comprising controlling the tilt angle of the flat reflective surface and the further tilt angle of the flat reflective surface, and any one or more objects or assemblies connected to the flat reflective surface, based on the determined change between the first and second tilt angles of the flat reflective surface around the pivot axis and the determined change between the first further and second further tilt angles of the flat reflective surface around the further pivot axis.

### Method for Orienting First and Second Objects Relative to One Another in 3D

According to an aspect of the present disclosure there is provided a method for use in orienting first and second objects relative to one another, the method comprising:
mounting an optical tilt sensor for use in sensing a tilt angle of a flat reflective surface around a pivot axis and a further tilt angle of the flat reflective surface around a further pivot axis as described above on a surface of a base member;
mounting the first object on the surface of the base member;
arranging the second object relative to the optical tilt sensor so that each emitted beam of light is incident on, and reflected from, a flat reflective surface of the second object to form the corresponding reflected beam of light, so that each further emitted beam of light is incident on, and reflected from, the flat reflective surface of the second object to form the corresponding further reflected beam of light, so that the sensor area of the image sensor detects an intensity distribution of each of the reflected beams of light and outputs one or more signals representative of the detected intensity distribution of each of the reflected beams of light, so that the sensor area of the image sensor detects an intensity distribution of each of the further reflected beams of light and outputs one or more further signals representative of the detected intensity distribution of each of the further reflected beams of light, so that each emission direction has a different known orientation relative to the pivot axis, and so that each further emission direction has a different known orientation relative to the further pivot axis;
determining a tilt angle of the flat reflective surface of the second object around the pivot axis and a further tilt angle of the flat reflective surface of the second object around the further pivot axis based at least in part on the one or more output signals, the one or more further output signals, the different known orientations of the different emission directions relative to the orientation of the sensor area of the image sensor, the different known orientations of the different further emission directions relative to the orientation of the sensor area of the image sensor, the known relative spatial relationship between the emission points, the known relative spatial relationship between the further emission points, the known orientation of each emission direction relative to the pivot axis, and the known orientation of each further emission direction relative to the further pivot axis; and
controlling the relative orientation of the first and second objects according to the determined tilt angle of the flat reflective surface of the second object and the determined further tilt angle of the flat reflective surface of the second object.

The first object may comprise a first component such as a first optical component or a first assembly such as a first assembly of optical components.

The second object may comprise a second component such as a second optical component or a second assembly such as a second assembly of optical components.

It should be understood that any one or more of the features of any one of the foregoing aspects of the present disclosure may be combined with any one or more of the features of any of the other foregoing aspects of the present disclosure.

### BRIEF DESCRIPTION OF THE DRAWINGS

An optical tilt sensor and associated apparatus and methods will now be described by way of non-limiting example only with reference to the accompanying drawings of which:

FIG. 1 is a schematic of an optical tilt sensor in use measuring the tilt of a flat reflective surface;

FIG. 2 is a schematic of a tilt measurement apparatus including the optical tilt sensor of FIG. 1 in use measuring the tilt of a flat reflective surface;

FIG. 3A is a detailed schematic of the optical tilt sensor of FIG. 1;

FIG. 3B shows a sensor area of an image sensor of the optical tilt sensor of FIG. 1 showing the intensity distribution resulting from the incidence of seven reflected beams of light on the sensor area of the image sensor;

FIG. 3C is a cross-sectional profile of the intensity distribution shown in FIG. 3B;

FIG. 4 is a schematic of a spatial filter for spatially filtering light emitted by an optical emitter of an optical emitter arrangement of the optical tilt sensor of FIG. 1;

FIG. 5A shows the sensor area of the image sensor of the optical tilt sensor of FIG. 1 showing the intensity distribution resulting from the incidence of seven reflected beams of light on the sensor area of the image sensor;

FIG. 5B is a cross-sectional profile of the intensity distribution shown in FIG. 5A;

FIG. 6 is a cross-sectional schematic showing the path travelled by a beam of light emitted by a spatial emitter arrangement of the optical tilt sensor of FIG. 1;

FIG. 7 is a schematic of an optical tilt control system for orienting a first object and a second object relative to one another;

FIG. 8 is a schematic of an alternative optical tilt control system for orienting a first assembly and a second assembly relative to one another;

FIG. 9 is a schematic of a first alternative spatial filter for spatially filtering light emitted by an optical emitter of an optical emitter arrangement of the optical tilt sensor of FIG. 1;

FIG. 10 is a schematic of a second alternative spatial filter for spatially filtering light emitted by an optical emitter of an optical emitter arrangement of the optical tilt sensor of FIG. 1;

FIG. 11 is a schematic of a third alternative spatial filter for spatially filtering light emitted by an optical emitter of an optical emitter arrangement of the optical tilt sensor of FIG. 1;

FIG. 12 is a schematic of a fourth alternative spatial filter for spatially filtering light emitted by an optical emitter of an optical emitter arrangement of the optical tilt sensor of FIG. 1;

FIG. 13 is a schematic of a fifth alternative spatial filter for spatially filtering light emitted by an optical emitter of an optical emitter arrangement of the optical tilt sensor of FIG. 1;

FIG. 14 is a schematic of a first alternative optical emitter arrangement for use in the optical tilt sensor of FIG. 1;

FIG. 15A is a schematic side-view of a first stage in the manufacture of an optical emitter of the first alternative optical emitter arrangement of FIG. 14;

FIG. 15B is a schematic perspective view of the first stage in the manufacture of the optical emitter of the first alternative optical emitter arrangement of FIG. 14;

FIG. 16A is a schematic side-view of a second stage in the manufacture of an optical emitter of the first alternative optical emitter arrangement of FIG. 14;

FIG. 16B is a schematic perspective view of the second stage in the manufacture of the optical emitter of the first alternative optical emitter arrangement of FIG. 14;

FIG. 17A is a schematic side-view of the optical emitter of the first alternative optical emitter arrangement of FIG. 14 when the optical emitter is in use;

FIG. 17B is a schematic perspective view of the optical emitter of the first alternative optical emitter arrangement of FIG. 14 when the optical emitter is in use;

FIG. 18A is a schematic of a second alternative optical emitter arrangement for use in the optical tilt sensor of FIG. 1;

FIG. 18B shows a diffraction pattern generated by the second alternative optical emitter arrangement of FIG. 18A;

FIG. 19 is a schematic of a third alternative optical emitter arrangement for use in the optical tilt sensor of FIG. 1;

FIG. 20A is a schematic of a fourth alternative optical emitter arrangement for use in the optical tilt sensor of FIG. 1, the fourth alternative optical emitter arrangement including an optical emitter and a diffractive optical element (DOE);

FIG. 20B shows a first example of a diffraction pattern formed using a first type of DOE in the optical emitter arrangement of FIG. 20A;

FIG. 20C shows a second example of a diffraction pattern formed using a second type of DOE in the optical emitter arrangement of FIG. 20A;

FIG. 20D shows a third example of a diffraction pattern formed using a third type of DOE in the optical emitter arrangement of FIG. 20A;

FIG. 21 is a schematic of a fifth alternative optical emitter arrangement for use in the optical tilt sensor of FIG. 1;

FIG. 22 is a plan view of a VCSEL array for use in a sixth alternative optical emitter arrangement for use in the optical tilt sensor of FIG. 1;

FIG. 23 is a schematic of a seventh alternative optical emitter arrangement for use in the optical tilt sensor of FIG. 1;

FIG. 24 is a schematic of an eighth alternative optical emitter arrangement for use in the optical tilt sensor of FIG. 1;

FIG. 25 is a schematic of a ninth alternative optical emitter arrangement for use in the optical tilt sensor of FIG. 1;

FIG. 26A is a detailed schematic of a 3D optical tilt sensor in use measuring the 3D tilt of a flat reflective surface when the flat reflective surface is parallel to a sensor area of an image sensor of the 3D optical tilt sensor;

FIG. 26B is a detailed schematic of the 3D optical tilt sensor of FIG. 26A in use measuring the 3D tilt of the flat reflective surface when the flat reflective surface is tilted at an angle relative to the sensor area of the image sensor of the 3D optical tilt sensor;

FIG. 27A shows the intensity distribution of each of the reflected beams of light and each of the further reflected beams of light incident on the sensor area of the image sensor corresponding to the 3D tilt angle of the flat reflective surface of FIG. 26A; and

FIG. 27B shows the intensity distribution of each of the reflected beams of light and each of the further reflected beams of light incident on the sensor area of the image sensor corresponding to the 3D tilt angle of the flat reflective surface of FIG. 26B.

### DETAILED DESCRIPTION OF THE DRAWINGS

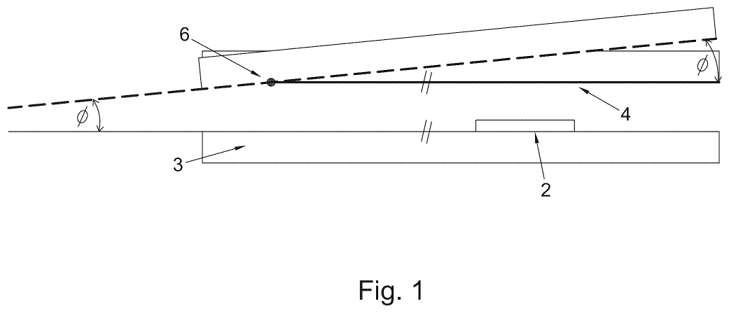

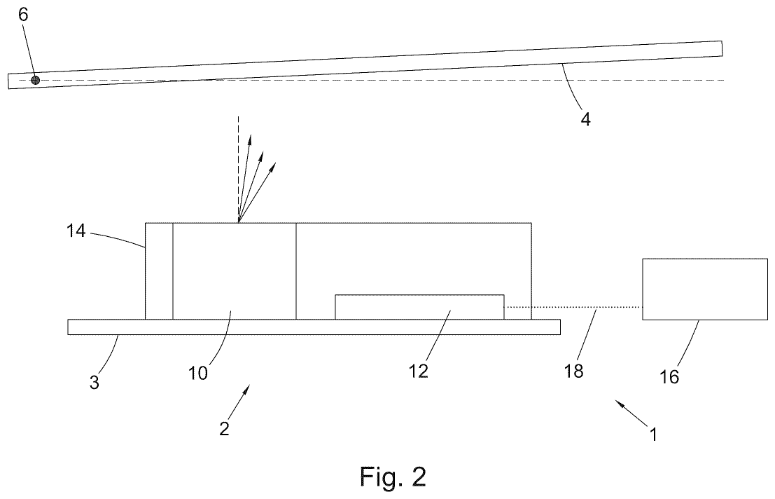

Referring initially to FIG. 1 there is shown an optical tilt sensor 2 mounted on a PCB 3 in use sensing a tilt angle ϕ of a flat reflective surface 4 around a pivot axis 6. The optical tilt sensor 2 is shown in more detail in FIG. 2 and includes an optical emitter arrangement 10, an image sensor 12 and a housing 14 to which the optical emitter arrangement 10 and the image sensor 12 are attached in a fixed spatial arrangement. The optical tilt sensor 2 forms part of a tilt measurement apparatus 1 which includes the optical tilt sensor 2 and a processing resource 16. The optical tilt sensor 2 is configured for communication with processing resource 16 via a communication link 18.

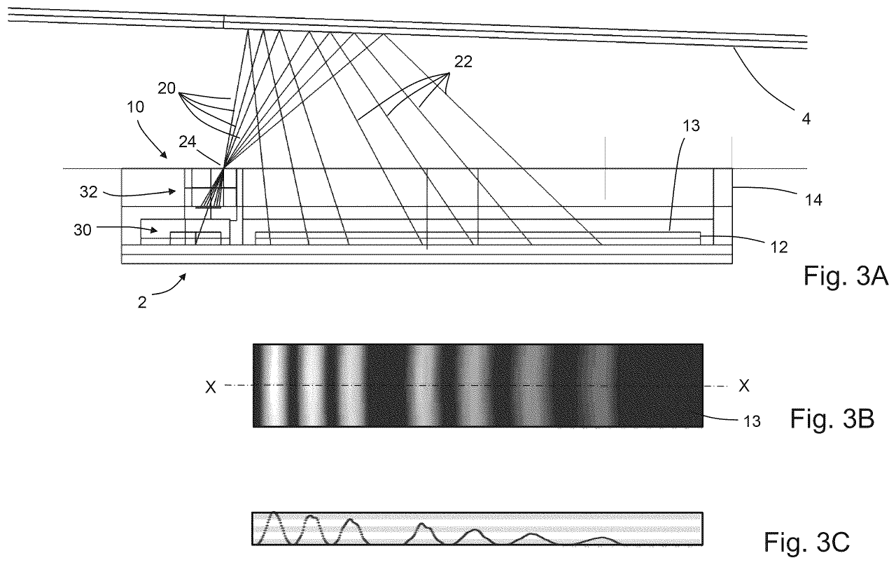

As shown in FIG. 3A, the optical emitter arrangement 10 includes an optical emitter 30 in the form of an LED or a laser diode such as a vertical cavity surface emitting laser (VCSEL) and a spatial filter 32 for spatially filtering light emitted by the optical emitter 30 so as to at least partially define at least three emitted beams of light 20.

As shown in FIGS. 3A-3C, the optical emitter arrangement 10 is configured to emit at least three beams of light 20 through an aperture or a window (not shown) in the housing 14 such that each emitted beam of light 20 is incident on, and reflected from, the flat reflective surface 4 to form a corresponding reflected beam of light 22 which passes through an aperture or a window (not shown) in the housing 14 and which is incident on a sensor area 13 of the image sensor 12. In the specific example shown in FIGS. 3A-3C, the optical emitter arrangement 10 is configured to emit seven beams of light 20 through an aperture or a window (not shown) in the housing 14 such that each emitted beam of light 20 is incident on, and reflected from, the flat reflective surface 4 to form a corresponding reflected beam of light 22 which passes through an aperture or a window (not shown) in the housing 14 and which is incident on a sensor area 13 of the image sensor 12. Each beam of light 22 is emitted along a corresponding different emission path, each emission path extending from a common emission point 24 along a different corresponding emission direction, wherein each emission direction has a different known orientation relative to an orientation of the sensor area 13 of the image sensor 12. As may be appreciated from FIG. 3A, an angular separation between the emission directions of one of the pairs of adjacent emitted beams 20 is different to an angular separation between the emission directions of the other pairs of adjacent emitted beams 20. Specifically, the angular separation between the third and fourth emitted beams 20 is different to an angular separation between each of the other pairs of adjacent emitted beams 20. As may be appreciated from FIGS. 3B and 3C, such an arrangement of the emission directions of the emitted beams 20 results in a corresponding arrangement of the directions of the reflected beams 22 and may assist with the identification of the intensity distributions on the sensor area 13 of the image sensor 12 corresponding to each of the emitted beams 20. The image sensor 12 detects the intensity distribution of each of the reflected beams of light 22 and outputs one or more signals representative of the detected intensity distribution of each of the reflected beams 22 incident on the sensor area 13 of the image sensor 12 for processing by the processing resource 16.

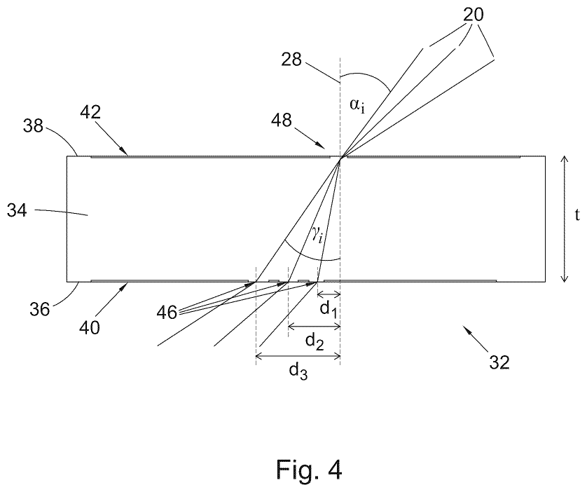

FIG. 4 shows the spatial filter 32 in more detail. The spatial filter 32 includes a transparent substrate 34 of a thickness t and formed from a glass material which defines an input surface 36 and an output surface 38. The spatial filter 32 is arranged so that the output surface 38 is parallel to the sensor area 13 of the image sensor 12. A patterned opaque coating 40 is formed from a metal such as chrome on the input surface 36 of the substrate 34, and a patterned opaque coating 42 is formed from a metal such as chrome on the output surface 38 of the substrate 34.

The patterned opaque coating 40 on the input surface 36 defines at least three input apertures 46 in the form of at least three slits. The patterned opaque coating 42 on the output surface 38 defines an output aperture 48 in the form of a pinhole. Each input aperture 46 has a known position and orientation relative to each of the other input apertures 46 and the output aperture 48. Each input aperture 46 is configured to receive light from the optical emitter 30. The output aperture 48 is configured to transmit light received from each input aperture 46 along a corresponding one of the emission paths to at least partially define a corresponding one of the at least three emitted beams of light 20. In effect, the output aperture 48 defines the common emission point 24.

One of ordinary skill in the art will understand that the thickness t of the substrate 34 may be measured or known to a high degree of accuracy and that the relative position and orientation of each of the input apertures 46 and the output aperture 48 may be controlled to a high degree of precision using modern lithographic manufacturing techniques so that the relative directions of the emitted beams of light 20 are also known to a high degree of precision. Specifically, a normal 28 may be defined which is perpendicular to the output surface 38 and which extends through the output aperture 48 and the angle αᵢ defined between the path of the i^{th} emitted beam 20 and the normal 28 may be known to a high degree of precision. The distance dᵢ of each input aperture 46 from the normal 28 along a direction perpendicular to the normal 28 for a given direction of emission defined by the angle at between the path of the i^{th} emitted beam 20 and the normal 28 may be calculated from:

dᵢ=t·tan(γᵢ) Equation (1)

and

n₁ sin(γᵢ)=n₂ sin(αᵢ) Equation (2)

where γᵢ is the angle with respect to the normal 28 of the paths along which light from the optical emitter 30 propagates inside the substrate 34 after transmission of the light by the different input apertures 46, n₁ is the refractive index of air, and n₂ is the refractive index of the substrate 34.

Substituting Equation (2) into Equation (1) then provides:

$${d}_{i} = t \cdot tan [ {sin}^{- 1} ( \frac{{n}_{2}}{{n}_{1}} sin ( {a}_{i} ) ) ] \qquad Equation ( 3 )$$

As may be appreciated from the convergence of the light incident on the input apertures 46 in FIG. 4, the optical emitter arrangement 10 includes a focussing element such as a lens (not shown in FIG. 3A or FIG. 4) which is configured to focus light emitted from the optical emitter 30 onto the output aperture 48.

Equation (3) may be used to design or select the relative spatial arrangement of the input apertures 46 and the output aperture 48 for a given angle αᵢ between the path of the i^{th} emitted beam 20 and the normal 28 to the output surface 38.

Conversely, for a given relative spatial arrangement of the input apertures 46 and the output aperture 48 defined by each horizontal distance dᵢ of each input aperture 46 from the normal 28, the direction of emission defined by the angle αᵢ may be calculated from:

$${α}_{i} = {sin}^{- 1} \{ \frac{{n}_{1}}{{n}_{2}} sin [ {tan}^{- 1} ( \frac{{d}_{i}}{t} ) ] \} \qquad Equation ( 4 )$$

It should be understood that each of the input apertures 46 and the output aperture 48 is configured so as to minimise diffraction of light transmitted through the apertures 46, 48. For example, each aperture 46, 48 may have a dimension which is greater than a wavelength of the light emitted by the optical emitter 30, at least 10 times greater than a wavelength of the light emitted by the optical emitter 30, or at least 100 times greater than a wavelength of the light emitted by the optical emitter 30.

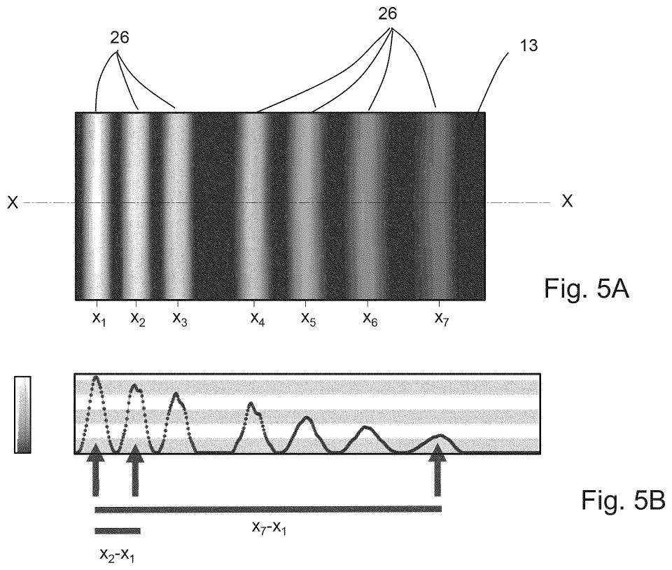

As shown in FIGS. 5A and 5B, the configuration of the optical emitter arrangement 10 and the arrangement of the optical emitter arrangement 10 and the image sensor 12 relative to the flat reflective surface 4 results in seven distinct, non-contiguous and/or non-overlapping intensity distributions 26 resulting from the incidence of the reflected beams 22 on the sensor area 13 of the image sensor 12, wherein the intensity distributions 26 have their peaks or centroids located at corresponding horizontal positions x₁ to x₇ on the sensor area 13.

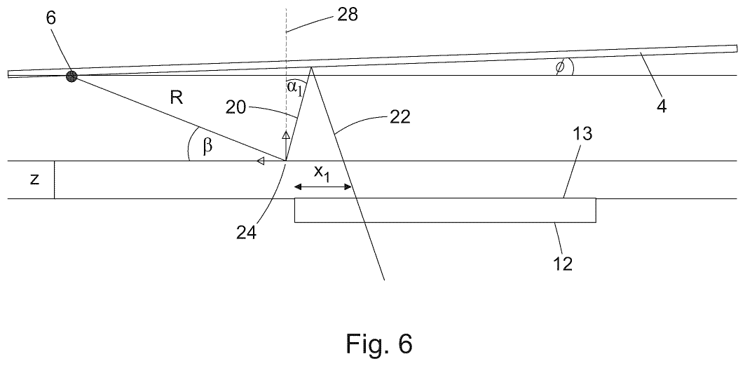

Referring now to FIG. 6, there is shown the flat reflective surface 4 arranged at a tilt angle to be measured of ϕ relative to the horizontal direction. The common emission point 24 is located at a height z above the sensor area 13 of the image sensor 12. The common emission point 24 and the pivot axis 6 lie on a straight line which defines an angle (90°−β) relative to the normal 28 and the common emission point 24 and the pivot axis 6 are separated by a distance R. A normal to the sensor area 13 of the image sensor 12 is aligned in the vertical direction 28. A first emitted beam 20 is emitted from the common emission point 24 along a first emission direction which defines an angle α₁ relative to the vertical direction 28 and is reflected from the flat reflective surface 4 to form a corresponding first reflected beam 22 which is incident on the sensor area 13 of the image sensor 12 at a horizontal distance x₁ from the common emission point 24. Based on trigonometry, it can be shown that x₁ is given by:

x₁=[2R sin(β+ϕ)+z]cos(ϕ)[tan(α₁+2ϕ)−tan(ϕ)] Equation (5)

Similarly, a second emitted beam (not shown in FIG. 6) is emitted from the common emission point 24 along a second emission direction which defines an angle α₂ relative to the vertical direction 28 and is reflected from the flat reflective surface 4 to form a corresponding second reflected beam (not shown in FIG. 6) which is incident on the sensor area 13 of the image sensor 12 at a horizontal distance x₂ from the common emission point 24 given by:

x₂=[2R sin(β+ϕ)+z]cos(ϕ)[tan(α₂+2ϕ)−tan(ϕ)] Equation (6)

and a third emitted beam (not shown in FIG. 6) is emitted from the common emission point 24 along a third emission direction which defines an angle α₃ relative to the vertical direction 28 and is reflected from the flat reflective surface 4 to form a corresponding third reflected beam (not shown in FIG. 6) which is incident on the sensor area 13 of the image sensor 12 at a horizontal distance x₃ from the common emission point 24 given by:

x₃=[2R sin(β+ϕ)+z]cos(ϕ)[tan(α₃+2ϕ)−tan(ϕ)] Equation (7)

where it is assumed that the paths of the first, second and third emitted beams all lie in a plane which is perpendicular to the pivot axis 6. Consequently, it follows that:

$${x}_{2} - {x}_{1} = [ 2 R sin ( β + ϕ ) + z ] cos ( ϕ ) [ tan ( {α}_{2} + 2 ϕ ) - tan ( {α}_{1} + 2 ϕ ) ] \qquad Equation ( 8 )$$

$${x}_{3} - {x}_{1} = [ 2 R sin ( β + ϕ ) + z ] cos ( ϕ ) [ tan ( {α}_{3} + 2 ϕ ) - tan ( {α}_{1} + 2 ϕ ) ] \qquad Equation ( 9 )$$

$$and$$

$$\frac{{x}_{3} - {x}_{1}}{{x}_{2} - {x}_{1}} = \frac{[ tan ( {α}_{3} + 2 ϕ ) - tan ( {α}_{1} + 2 ϕ ) ]}{[ tan ( {α}_{2} + 2 ϕ ) - tan ( {α}_{1} + 2 ϕ ) ]} \qquad Equation ( 10 )$$

In use, the processing resource 16 receives one or more output signals from the image sensor 12, wherein the one or more output signals are representative of the detected intensity distribution of each of the reflected beams of light 22 and the processing resource 16 solves Equation (10) to determine the tilt angle ϕ of the flat reflective surface 4 based at least in part on the one or more received output signals, the different known orientations of the different emission directions α₁, α₂, and α₃ of the at least three emitted beams 20 relative to the orientation of the sensor area 13 of the image sensor 12, and the fact that the emitted beams 20 all extend from the common emission point 24.

Specifically, the processing resource 16 uses Equation (10) to determine the tilt angle ϕ of the flat reflective surface 4 from the known angles α₁, α₂ and α₃, the spacing x₂−x₁ of the peaks or centroids of the intensity peaks formed when the first and second reflected beams are incident on the sensor area 13 of the image sensor 12, and the spacing x₃−x₁ of the peaks or centroids of the intensity peaks formed when the first and third reflected beams are incident on the sensor area 13 of the image sensor 12. Moreover, one of ordinary skill in the art will understand that the right-hand side of Equation (10) does not depend on the distance R from the common emission point 24 to the pivot axis 6, the distance from the common emission point 24 to the flat reflective surface 4, the horizontal distance from the common emission point 24 to the active area 13 of the image sensor 12, or the vertical distance z from the common emission point 24 to the active area 13 of the image sensor 12 or the reflectivity of the flat reflective surface 4. As such, the optical tilt sensor 2 may be used to determine the tilt angle ϕ of the flat reflective surface 4 around the pivot axis 6 with high accuracy, even where the distance from the optical tilt sensor 2 to the flat reflective surface 4 is unknown (or is at least not precisely known), even where the distance R from the optical tilt sensor 2 to the pivot axis 6 is unknown (or is at least not precisely known), and without any need to calibrate the optical tilt sensor 2. Furthermore, although the pivot axis 6 is shown as being located on the flat reflective surface 4 in FIG. 6, it will be appreciated from Equation (10) that there is no requirement for the pivot axis 6 to be on the flat reflective surface 4 and that, in general, the pivot axis 6 may be displaced or offset from the flat reflective surface 4.

As may be appreciated from FIGS. 5A and 5B, the angular separation between the emission directions of one or more pairs of adjacent emitted beams 20 is different to an angular separation between the emission directions of the other pairs of adjacent emitted beams 20. Specifically, the optical emitter arrangement 10 is configured to emit first, second, third, fourth, fifth, sixth and seventh beams of light 20 along first, second, third, fourth, fifth, sixth and seventh different corresponding emission directions, wherein an angular separation between the third and fourth emitted beams is different to an angular separation between the first and second emitted beams, an angular separation between the second and third emitted beams, an angular separation between the fourth and fifth emitted beams, an angular separation between the fifth and sixth emitted beams, and an angular separation between the sixth and seventh emitted beams. When an angular separation between the emission directions of one or more pairs of adjacent emitted beams 20 is different to an angular separation between the emission directions of the other pairs of adjacent emitted beams 20 in this way, the resulting intensity distributions of the reflected beams 22 on the sensor area 13 of the image sensor 12 may have a characteristic pattern which may assist with the identification of the intensity distributions on the sensor area 13 of the image sensor 12 corresponding to each of the emitted beams 20. This may be particularly useful when the optical tilt sensor 2 and the flat reflective surface 4 are arranged so that some, but not all of the, reflected beams 22 are incident on the sensor area 13 of the image sensor 12.

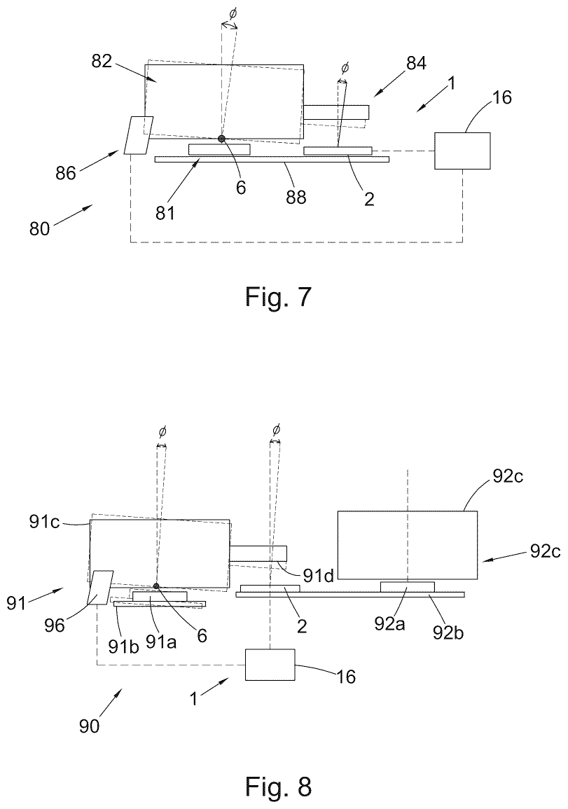

Referring now to FIG. 7 there is shown an optical tilt control system generally designated 80 for orienting a first object 81 and a second object 82 relative to one another. The first object 81 may, for example, be an image sensor (for a camera application) or an image generator (for a projector application). The second object 82 may, for example, be an optical component or optical system such as a lens barrel. The second object 82 includes a flat reflective probe surface 84. The optical tilt control system 80 includes the tilt measurement apparatus 1 and a tilt actuator 86 for adjusting a tilt angle of the second object 82 including the flat reflective probe surface 84 around a pivot axis 6. The optical tilt sensor 2 of the tilt measurement apparatus 1 and the first object 81 are mounted on a common base member in the form of a PCB 88 with the flat reflective probe surface 84 of the second object 82 located above the optical tilt sensor 2. It should be appreciated from FIG. 7 that, in general, the pivot axis 6 does not lie on the flat reflective probe surface 84.

In use, the processing resource 16 determines the tilt angle of the flat reflective probe surface 84 based at least in part on one or more output signals received from the optical tilt sensor 2, the different known orientations of the different emission directions α₁, α₂, and α₃ of the at least three emitted beams 20 relative to the orientation of the sensor area 13 of the image sensor 12, and the fact that the emitted beams 20 all extend from the common emission point 24. The processing resource 16 then controls the tilt actuator 86 so as to control the tilt angle of the second object 82 relative to the first object 81 based on the determined tilt angle of the flat reflective probe surface 84 of the second object 82 to thereby achieve a desired tilt angle or orientation of the second object 82 relative to the first object 81.

Referring now to FIG. 8 there is shown an alternative optical tilt control system generally designated 90 for orienting a first assembly 91 and a second assembly 92 relative to one another. The first assembly 91 may, for example, be an assembly of optical components which includes a first optical component 91a such as an image generator mounted on a base member 91b such as a PCB, and a second optical component 91c such as a lens barrel which is aligned and attached to the first optical component 91a. The first assembly 91 further includes a flat reflective probe surface 91d. The second assembly 92 may, for example, be an assembly of optical components which includes a first optical component such as an image sensor 92a mounted on a base member 92b such as a PCB, and a second optical component 92c such as a lens barrel which is aligned and attached to the first optical component 92a. The optical tilt control system 90 includes the tilt measurement apparatus 1 and a tilt actuator 96 for adjusting a tilt angle of the first assembly 91 including the flat reflective probe surface 91d around a pivot axis 6. The optical tilt sensor 2 of the tilt measurement apparatus 1 is mounted on the PCB 92b of the second assembly 92 with the flat reflective probe surface 91d of the first assembly 91 located above the optical tilt sensor 2. It should be appreciated from FIG. 8 that, in general, the pivot axis 6 does not lie on the flat reflective probe surface 91d.

In use, the processing resource 16 determines the tilt angle of the flat reflective probe surface 91d based at least in part on one or more output signals received from the optical tilt sensor 2, the different known orientations of the different emission directions α₁, α₂, and α₃ of the at least three emitted beams 20 relative to the orientation of the sensor area 13 of the image sensor 12, and the fact that the emitted beams 20 all extend from the common emission point 24. The processing resource 16 then controls the tilt actuator 96 so as to control the tilt angle of the first assembly 91 based on the determined tilt angle of the flat reflective probe surface 91d of the first assembly 91 to thereby achieve a desired tilt angle or orientation of the first assembly 91 relative to the second assembly 92.

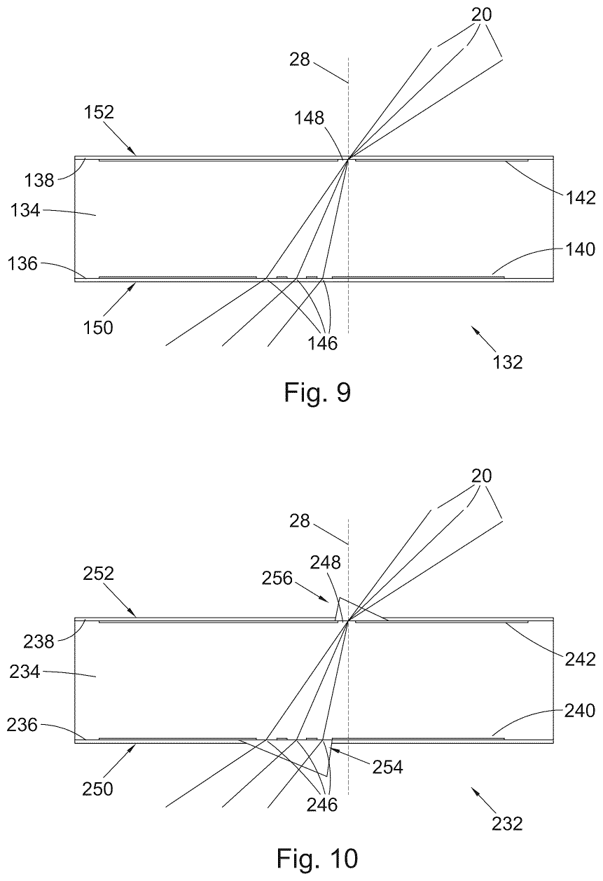

Referring now to FIG. 9 there is shown a first alternative spatial filter 132 for spatially filtering light emitted by the optical emitter 30. The spatial filter 132 shares many like features with the spatial filter 32 of FIG. 4 with the features of the spatial filter 132 of FIG. 9 being identified with the same reference numerals as the corresponding features of the spatial filter 32 of FIG. 4 incremented by “100”. Specifically, the spatial filter 132 includes a transparent substrate 134 formed from a glass material which defines an input surface 136 and an output surface 138. A patterned opaque coating 140 is formed from a metal such as chrome on the input surface 136 of the substrate 134, and a patterned opaque coating 142 is formed from a metal such as chrome on the output surface 138 of the substrate 134.

The patterned opaque coating 140 on the input surface 136 defines at least three input apertures 146 in the form of at least three slits. The patterned opaque coating 142 on the output surface 38 defines an output aperture 148 in the form of a pinhole. Each input aperture 146 has a known position and orientation relative to each of the other input apertures 146 and the output aperture 148. The input apertures 146 are offset horizontally relative to the normal 28 to the output surface 138 which extends through the output aperture 148.

A protective layer of transparent UV-cured material 150 such as cured UV epoxy is formed on the patterned opaque coating 140 and a protective layer of transparent UV-cured material 152 such as cured UV epoxy is formed on the patterned opaque coating 142. The UV-cured material of the layers 150, 152 may have a refractive index n₃ which is intermediate in value between the refractive index n₁=1 of air and the refractive index n₂ of the substrate 134. For example, the refractive index n₂ of the substrate 34 may be around 1.5 and the refractive index n₃ of the UV-cured material of the layers 150, 152 may be around 1.45.

Each input aperture 146 is configured to receive light from the optical emitter 30. The output aperture 148 is configured to transmit light received from each input aperture 146 along a corresponding one of the emission paths to at least partially define a corresponding one of the at least three emitted beams of light 20. In effect, the output aperture 148 defines the common emission point 24.

Referring now to FIG. 10 there is shown a second alternative spatial filter 232 for spatially filtering light emitted by the optical emitter 30. The spatial filter 232 shares many like features with the spatial filter 132 of FIG. 9 with the features of the spatial filter 232 of FIG. 10 being identified with the same reference numerals as the corresponding features of the spatial filter 132 of FIG. 9 incremented by “100”. Specifically, the spatial filter 232 includes a transparent substrate 234 formed from a glass material which defines an input surface 236 and an output surface 238. A patterned opaque coating 240 is formed from a metal such as chrome on the input surface 236 of the substrate 234, and a patterned opaque coating 242 is formed from a metal such as chrome on the output surface 238 of the substrate 234.

The patterned opaque coating 240 on the input surface 236 defines at least three input apertures 246 in the form of at least three slits. The patterned opaque coating 242 on the output surface 238 defines an output aperture 248 in the form of a pinhole. Each input aperture 246 has a known position and orientation relative to each of the other input apertures 246 and the output aperture 248. The input apertures 246 are offset horizontally relative to the normal 28 to the output surface 238 which extends through the output aperture 248.

UV-curable material such as UV-curable epoxy is formed on, or applied to, the patterned opaque coating 240 and shaped, for example by molding or embossing, and cured so as to define a layer of UV-cured material 250 which includes an input micro-prism 254 which covers the input apertures 246. Similarly, UV-curable material such as UV-curable epoxy is formed on, or applied to, the patterned opaque coating 242 and shaped, for example by molding or embossing, and cured so as to define a layer of UV-cured material 252 which includes an output micro-prism 256 which covers the output aperture 248. The UV-cured material of the layers 250, 252 may have a refractive index n₃ which is intermediate in value between the refractive index n₁=1 of air and the refractive index n₂ of the substrate 34. For example, the refractive index n₂ of the substrate 234 may be around 1.5 and the refractive index n₃ of the UV-cured material of the layers 250, 252 may be around 1.45.

Each input aperture 246 is configured to receive light from the optical emitter 30. The output aperture 248 is configured to transmit light received from each input aperture 246 along a corresponding one of the emission paths to at least partially define a corresponding one of the at least three emitted beams of light 20. In effect, the output aperture 248 defines the common emission point 24.

The input micro-prism 254 serves to improve the efficiency of the transmission of light from the optical emitter 30 into the substrate 234 via the input apertures 246. Similarly, the output micro-prism 256 serves to improve the efficiency of the transmission of light out of the substrate 234 via the output aperture 248. One of ordinary skill in the art will understand that the presence of the input micro-prism 254 and the presence of the output micro-prism 256 will affect the corresponding emission directions of the at least three emitted beams of light 20 in a way that may be predicted based at least in part on the geometries of the input and output micro-prisms 254, 256 and the refractive index n₃ of the UV-cured material.

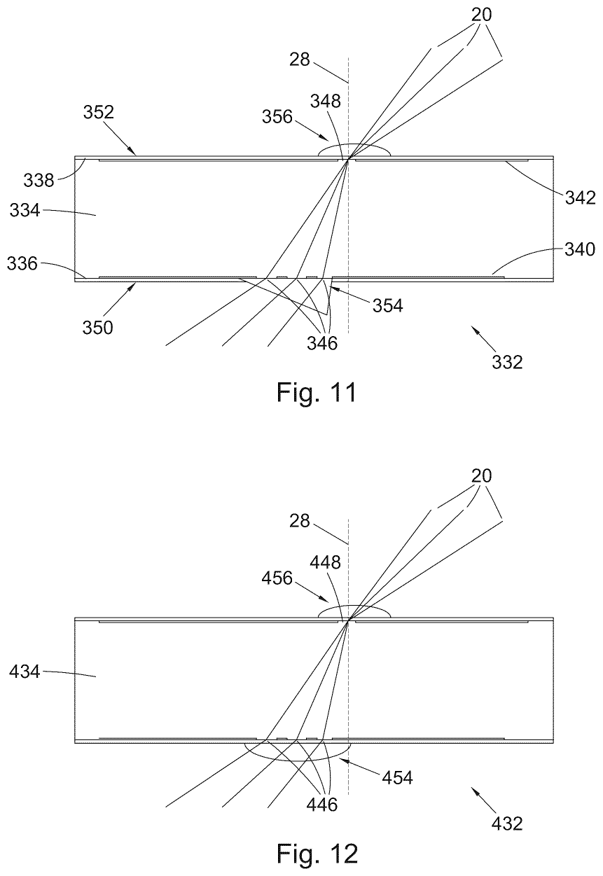

Referring now to FIG. 11 there is shown a third alternative spatial filter 332 for spatially filtering light emitted by the optical emitter 30. The spatial filter 332 shares many like features with the spatial filter 232 of FIG. 10 with the features of the spatial filter 332 of FIG. 11 being identified with the same reference numerals as the corresponding features of the spatial filter 232 of FIG. 10 incremented by “100”. Specifically, the spatial filter 332 includes a transparent substrate 334 formed from a glass material which defines an input surface 336 and an output surface 338. A patterned opaque coating 340 is formed from a metal such as chrome on the input surface 336 of the substrate 334, and a patterned opaque coating 342 is formed from a metal such as chrome on the output surface 338 of the substrate 334.

The patterned opaque coating 340 on the input surface 336 defines at least three input apertures 346 in the form of at least three slits. The patterned opaque coating 342 on the output surface 338 defines an output aperture 348 in the form of a pinhole. Each input aperture 346 has a known position and orientation relative to each of the other input apertures 346 and the output aperture 348. The input apertures 346 are offset horizontally relative to the normal 28 to the output surface 338 which extends through the output aperture 348.

UV-curable material such as UV-curable epoxy is formed on, or applied to, the patterned opaque coating 340 and shaped, for example by moulding or embossing, and cured so as to define a layer of UV-cured material 350 which includes an input micro-prism 354 which covers the input apertures 346. Similarly, UV-curable material such as UV-curable epoxy is formed on, or applied to, the patterned opaque coating 342 and shaped, for example by moulding or embossing, and cured so as to define a layer of UV-cured material 352 which includes an output micro-lens 356 which covers the output aperture 348. The UV-cured material of the layers 350, 352 may have a refractive index n₃ which is intermediate in value between the refractive index n₁=1 of air and the refractive index n₂ of the substrate 34. For example, the refractive index n₂ of the substrate 334 may be around 1.5 and the refractive index n₃ of the UV-cured material of the layers 350, 352 may be around 1.45.

The input micro-prism 354 serves to improve the efficiency of the transmission of light from the optical emitter 30 into the substrate 334 via the input apertures 346. Similarly, the UV-cured output micro-lens 356 serves to improve the efficiency of the transmission of light out of the substrate 334 via the output aperture 348 whilst also collimating, or at least reducing the divergence of, each of the emitted beams of light 20.

Referring now to FIG. 12 there is shown a fourth alternative spatial filter 432 for spatially filtering light emitted by the optical emitter 30. The spatial filter 432 shares many like features with the spatial filter 332 of FIG. 11 with the features of the spatial filter 432 of FIG. 12 being identified with the same reference numerals as the corresponding features of the spatial filter 332 of FIG. 11 incremented by “100”. Specifically, the spatial filter 432 includes a transparent substrate 434, an input micro-lens 454 which covers input apertures 446 and an output micro-lens 456 which covers output aperture 448. The input apertures 446 are offset horizontally relative to the normal 28 which extends through the output aperture 448.

The input micro-lens 454 serves to improve the efficiency of the transmission of light from the optical emitter 30 into the substrate 434 via the input apertures 446 whilst also collimating, or at least reducing the divergence of, the light from the optical emitter 30 before the light enters the substrate 434. Similarly, the output micro-lens 456 serves to improve the efficiency of the transmission of light out of the substrate 434 via the output aperture 448 whilst also collimating, or at least reducing the divergence of, each of the emitted beams of light 20.

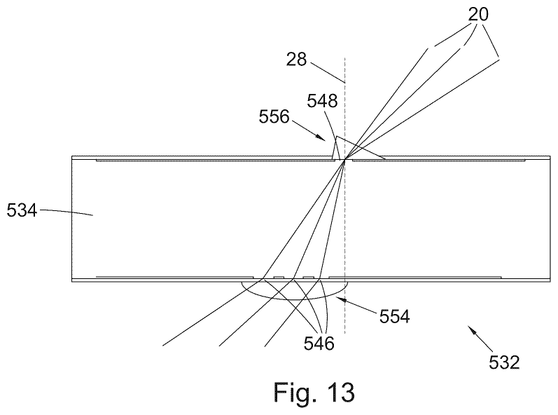

Referring now to FIG. 13 there is shown a fifth alternative spatial filter 532 for spatially filtering light emitted by the optical emitter 30. The spatial filter 532 shares many like features with the spatial filter 432 of FIG. 12 with the features of the spatial filter 532 of FIG. 13 being identified with the same reference numerals as the corresponding features of the spatial filter 432 of FIG. 12 incremented by “100”. Specifically, the spatial filter 532 includes a transparent substrate 534, an input micro-lens 554 which covers input apertures 546 and an output micro-prism 556 which covers output aperture 548. The input apertures 546 are offset horizontally relative to the normal 28 which extends through the output aperture 548.

The input micro-lens 554 serves to improve the efficiency of the transmission of light from the optical emitter 30 into the substrate 534 via the input apertures 546 whilst also collimating, or at least reducing the divergence of, the light from the optical emitter 30 before the light enters the substrate 534. Similarly, the output micro-prism 556 serves to improve the efficiency of the transmission of light out of the substrate 534 via the output aperture 548 to form each of the emitted beams of light 20.

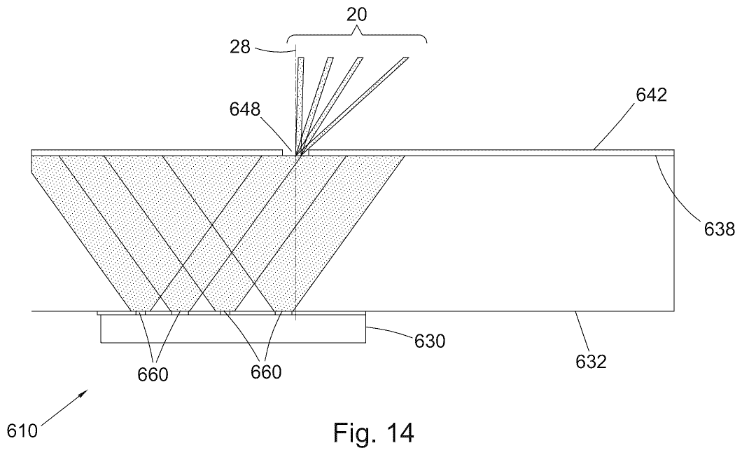

Referring now to FIG. 14 there is shown a first alternative optical emitter arrangement generally designated 610 for use in the optical tilt sensor 2. The first alternative optical emitter arrangement 610 includes an optical emitter 630 in the form of a structured LED and a sixth alternative spatial filter 632, wherein an upper surface of the structured LED 630 is aligned with a lower surface of the spatial filter 632.

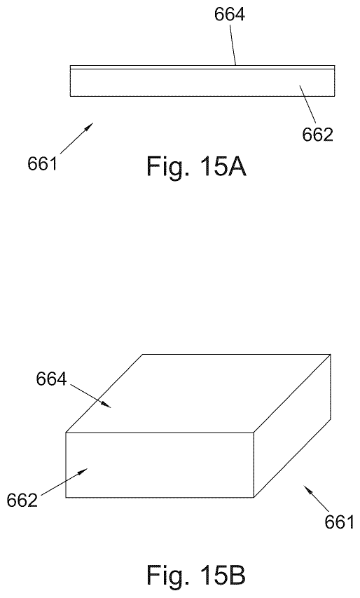

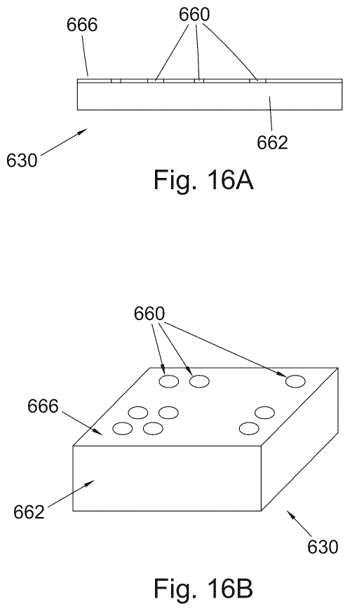

The structured LED 630 defines a plurality of light emitting apertures or windows 660 on an upper surface thereof. The spatial filter 632 includes a transparent substrate 634. An opaque coating 642 is formed from a metal such as chrome on an upper surface 638 of the substrate 634 and patterned so as to define an aperture in the form of a pinhole 648 for spatially filtering light emitted by the structured LED 630 through the light emitting apertures or windows 660 after transmission through the substrate 634. The manufacture of the structured LED 630 is described with reference to FIGS. 15A, 15B, 16A, 16B, 17A and 17B. Specifically, as shown in FIGS. 15A and 15B, the structured LED 630 is manufactured by first providing an LED generally designated 661 which includes a die 662 having a light emitting surface 664. As shown in FIGS. 16A and 16B, an opaque coating 666 is then deposited or formed on the light emitting surface 664 and patterned so as to form the plurality of apertures or windows 660.

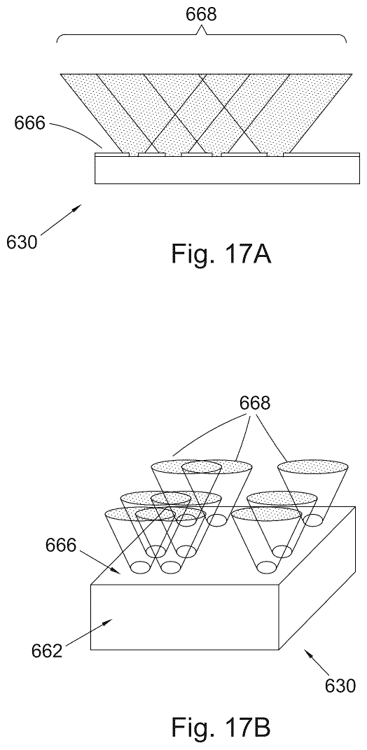

In use, as shown in FIGS. 17A and 17B, the structured LED 630 emits an initial divergent beam of light 668 from each aperture or window 660. Referring back to FIG. 14, the structured LED 630 and the spatial filter 632 are aligned relative to one another in a known relative spatial configuration so that the light emitting apertures or windows 660 are offset horizontally relative to the normal 28 which extends through the pinhole 648. The initial divergent beam of light 668 emitted from each aperture or window 660 is transmitted through the substrate 634 and at least a portion of at least three of the initial divergent beams of light 668 is transmitted by the pinhole 648 so as to at least partially define the at least three emitted beams of light 20, wherein each emitted beam of light 20 is emitted along a different corresponding emission direction, and wherein each emission direction has a different known orientation relative to an orientation of the sensor area 13 of the image sensor 12.

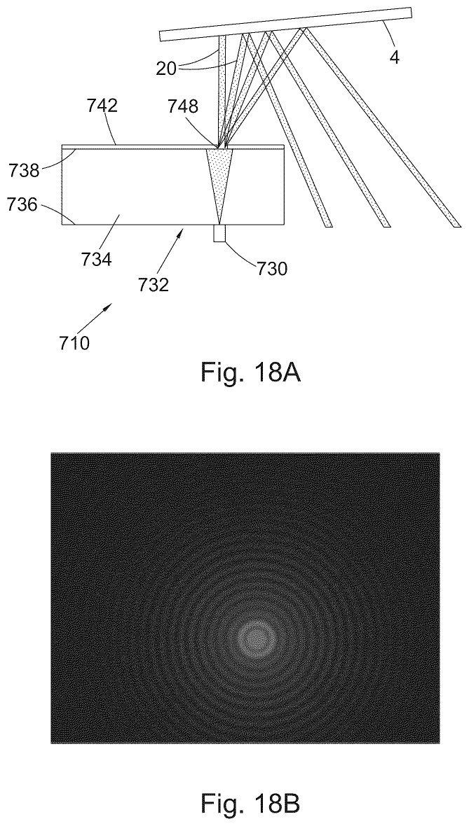

Referring now to FIG. 18A there is shown a second alternative optical emitter arrangement generally designated 710 for use in the optical tilt sensor 2. The second alternative optical emitter arrangement 710 includes an optical emitter 730 and a seventh alternative spatial filter 732 for spatially filtering light emitted by the optical emitter 730. The spatial filter 732 includes a transparent substrate 734 formed from a glass material which defines an input surface 736 and an output surface 738. A patterned opaque coating 742 is formed from a metal such as chrome on the output surface 738 of the substrate 734.

The patterned opaque coating 742 on the output surface 738 defines an output aperture 748 in the form of a pinhole which is configured to diffract light transmitted through the aperture 748, for example wherein the aperture 748 has a dimension which is less than 100 times greater than a wavelength of the light emitted by the optical emitter 30, less than 10 times greater than a wavelength of the light emitted by the optical emitter 30, or less than or equal to a wavelength of the light emitted by the optical emitter 30.

Light from the optical emitter 730 diverges inside the substrate 734 and is diffracted by the output aperture 748 so as to form a diffraction pattern shown in FIG. 18B which includes a central spot and a plurality of circular fringes, wherein the central spot and the circular fringes are concentric. As will be appreciated by one of ordinary skill in the art, the precise geometry of the diffraction pattern depends on, and may be predicted from, the size of the pinhole 748, the spectral properties or the wavelength of the light emitted by the optical emitter 730, and the divergence of the light emitted by the optical emitter 730. The diffracted light 20 is reflected from the flat reflected surface 4 and captured on the sensor area 13 of the image sensor 12 (not shown in FIG. 18A).

The size of the pinhole 748, the spectral properties or the wavelength of the light emitted by the optical emitter 730, and the divergence of the light emitted by the optical emitter 730 are selected so that, when viewed in cross-section as shown in FIG. 18A, the diffracted light may be considered to include at least three beams of light 20 which are emitted along at least three corresponding different emission paths, each emission path extending from the pinhole 748 along a different corresponding emission direction, wherein each emission direction has a different known orientation relative to an orientation of the sensor area 13 of the image sensor 12.

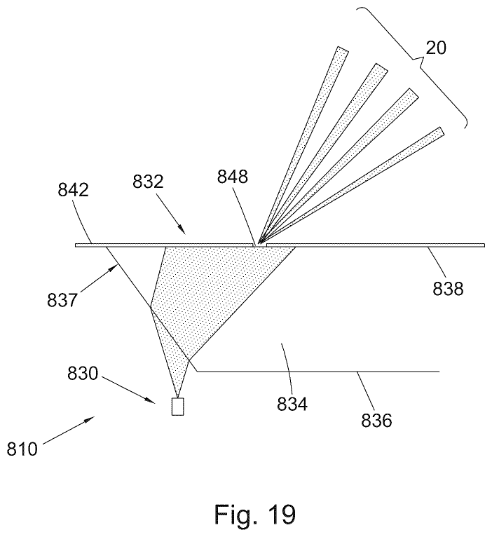

Referring now to FIG. 19 there is shown a third alternative optical emitter arrangement generally designated 810 for use in the optical tilt sensor 2. The third alternative optical emitter arrangement 810 includes an optical emitter 830 and an eighth alternative spatial filter 832 for spatially filtering light emitted by the optical emitter 830. The spatial filter 832 includes a transparent substrate 834 formed from a glass material which defines a lower surface 836, an input surface or edge 837, and an upper or output surface 838. The lower surface 836 and the upper or output surface 838 are generally parallel. The input surface or edge 837 defines an acute angle relative to the upper or output surface 838. A patterned opaque coating 842 is formed from a metal such as chrome on the upper or output surface 838 of the substrate 834.

The patterned opaque coating 842 on the upper or output surface 838 defines an output aperture 848 in the form of a pinhole which is configured to diffract light transmitted through the aperture 848, for example wherein the aperture 848 has a dimension which is less than 100 times a wavelength of the light emitted by the optical emitter 830, less than 10 times a wavelength of the light emitted by the optical emitter 830, or less than or equal to a wavelength of the light emitted by the optical emitter 830.

Light emitted from the optical emitter 830 travels along a direction which is generally normal to the lower surface 836 of the substrate 834, enters the substrate 834 through the input surface or edge 837, and is refracted away from the normal. The light diverges inside the substrate 834 and is diffracted by the output aperture 848 so as to form diffracted light 20. As will be appreciated by one of ordinary skill in the art, the precise geometry of the diffraction pattern of the diffracted light 20 depends on, and may be predicted from, the size of the pinhole 848, the spectral properties or the wavelength of the light emitted by the optical emitter 830, and the divergence of the light emitted by the optical emitter 830. The diffracted light 20 is reflected from the flat reflected surface 4 and captured on the sensor area 13 of the image sensor 12 (not shown in FIG. 19).

The size of the pinhole 848, the spectral properties or the wavelength of the light emitted by the optical emitter 830, and the divergence of the light emitted by the optical emitter 830 are selected so that, when viewed in cross-section as shown in FIG. 19, the diffracted light may be considered to include at least three beams of light 20 which are emitted along at least three corresponding different emission paths, each emission path extending from the pinhole 848 along a different corresponding emission direction, wherein each emission direction has a different known orientation relative to an orientation of the sensor area 13 of the image sensor 12. The third alternative optical emitter arrangement 810 of FIG. 19 may be particularly suitable for use with an optical emitter 830 which is surface-emitting because an upper surface of the optical emitter 830 may be readily aligned, for example brought into engagement with, the lower surface 836 of the substrate 834.

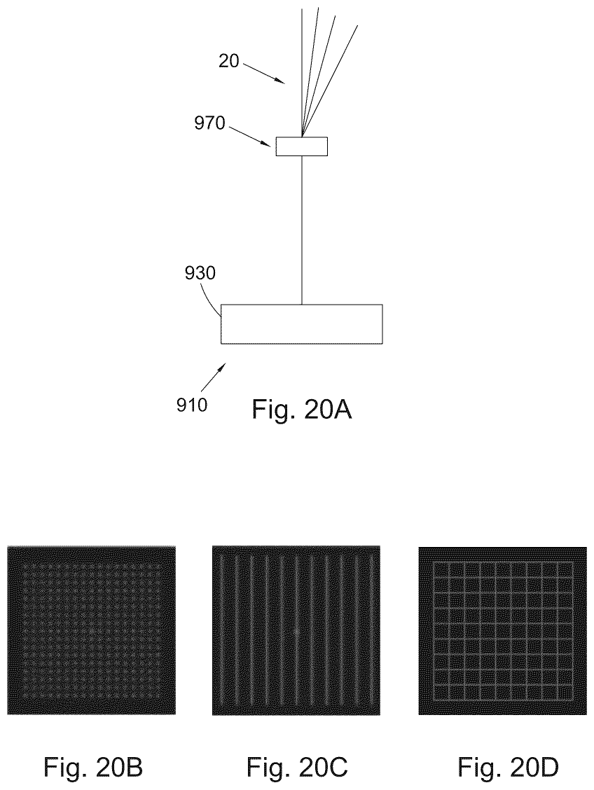

Referring now to FIG. 20A there is shown a fourth alternative optical emitter arrangement generally designated 910 for use in the optical tilt sensor 2. The fourth alternative optical emitter arrangement 910 includes an optical emitter 930 and a diffractive optical element (DOE) 970 for diffracting light emitted by the optical emitter 930 so as to deform diffracted light which includes at least three beams of light 20 which are emitted along at least three corresponding different emission paths, each emission path extending from the same position on the DOE along a different corresponding emission direction, wherein each emission direction has a different known orientation relative to an orientation of the sensor area 13 of the image sensor 12.

FIG. 20B shows a first example of a diffraction pattern in the form of a plurality of spots formed using a first type of DOE 970. FIG. 20C shows a second example of a diffraction pattern in the form of a regular 1D array of lines formed using a sixth type of DOE 970. FIG. 20D shows a third example of a diffraction pattern in the form of a grid pattern formed using a third type of DOE 970. As will be appreciated by one of ordinary skill in the art, any of the diffraction patterns of FIGS. 20B to 20D may be considered to be formed from at least three beams of light 20 which are emitted along at least three corresponding different emission paths.

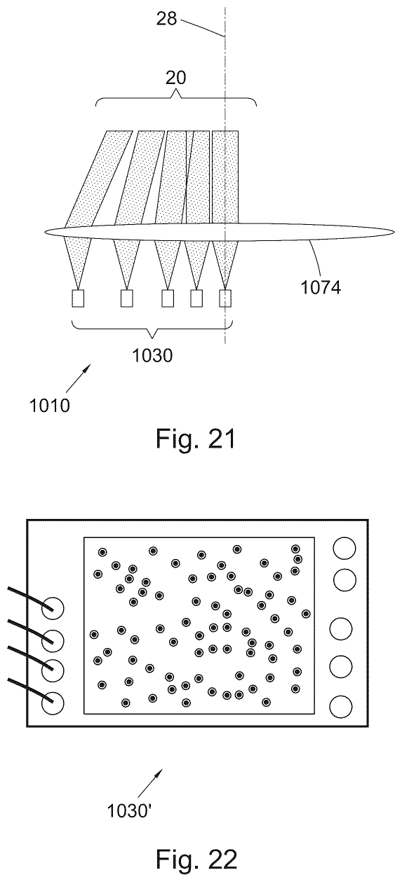

Referring now to FIG. 21 there is shown a fifth alternative optical emitter arrangement generally designated 1010 for use in the optical tilt sensor 2. The fifth alternative optical emitter arrangement 1010 includes a plurality of discrete optical emitters in the form of a plurality of discrete VCSELs 1030 and a lens 1074, wherein each of the VCSELs 1030 has a known relative spatial relationship relative to each of the other VCSELs 1030 and the lens 1074.

In use, light diverges from each VCSEL 1030 whilst travelling along a path which is generally parallel to the optical axis 28 of the lens 1074. The lens 1074 collimates and refracts the light emitted from each VCSEL 1030 so as to form at least three beams of light 20 which are emitted along at least three corresponding different emission paths, each emission path extending from a different known emission position on the lens 1074 along a different corresponding emission direction, wherein each emission direction has a different known orientation relative to an orientation of the sensor area 13 of the image sensor 12. In this regard, one of ordinary skill in the art will understand that Equation (10) may be readily adapted to account for the different known emission positions of the at least three beams of light 20 on the lens 1074 to allow the tilt angle of the flat reflective surface 4 to be determined from the measured spacing x₂−x₁ of the peaks or centroids of the intensity peaks formed when the first and second reflected beams 22 are incident on the sensor area 13 of the image sensor 12, and the measured spacing x₃−x₁ of the peaks or centroids of the intensity peaks formed when the first and third reflected beams are incident on the sensor area 13 of the image sensor 12.

Referring now to FIG. 22 there is shown a monolithic VCSEL array 1030′ of a sixth alternative optical emitter arrangement for use in the optical tilt sensor 2. As will be understood by one of ordinary skill in the art, the individual VCSEL elements of the VCSEL array 1030′ are defined lithographically with the result that the relative spatial arrangement of the individual VCSEL elements of the monolithic VCSEL array 1030′ is known with a high degree of precision. 1. The sixth alternative optical emitter arrangement includes a lens (not shown) analogous to the lens 1074 of the fifth alternative optical emitter arrangement 1010 of FIG. 21, wherein the lens is positioned above the VCSEL array 1030′, such that each of the VCSEL elements of the monolithic VCSEL array 1030′ has a known relative spatial relationship relative to each of the other VCSEL elements of the monolithic VCSEL array 1030′ and the lens.

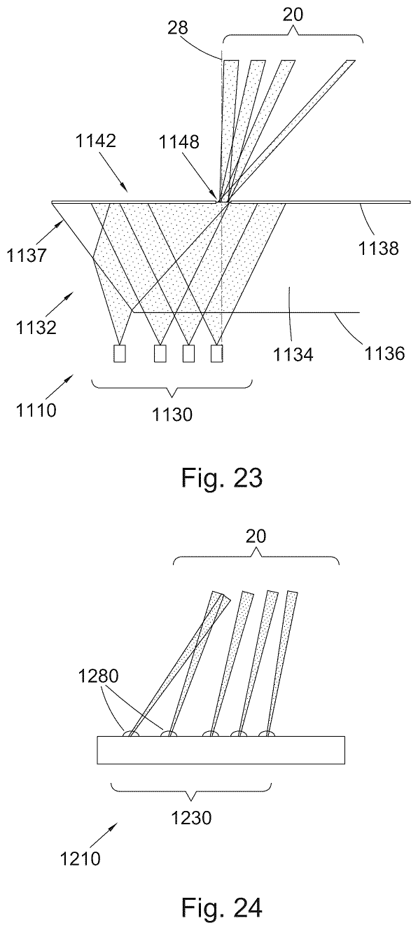

Referring now to FIG. 23 there is shown a seventh alternative optical emitter arrangement generally designated 1110 for use in the optical tilt sensor 2. The seventh alternative optical emitter arrangement 1110 includes a plurality of optical emitters in the form of a plurality of discrete VCSELs 1130 and a corresponding spatial filter 1132 for spatially filtering light emitted by the VCSELs 1130.

The spatial filter 1132 includes a transparent substrate 1134 formed from a glass material which defines a lower surface 1136, an edge 1137, and an upper or output surface 1138. The lower surface 1136 and the upper or output surface 1138 are generally parallel. The edge 1137 defines an acute angle relative to the upper or output surface 1138. A patterned opaque coating 1142 is formed from a metal such as chrome on the upper or output surface 1138 of the substrate 1134. The patterned opaque coating 1142 on the upper or output surface 1138 defines an output aperture 1148 in the form of a pinhole. Each of the VCSELs 1130 has a known relative spatial relationship relative to each of the other VCSELs and the output pinhole 1148. Each of the VCSELs 1130 is offset horizontally relative to the normal 28 to the output surface 1138 of the substrate 1134 which extends through the pinhole 1148.

Light emitted from each of the VCSELs 1130 travels along a corresponding direction which is generally normal to the lower surface 1136 of the substrate 1134. Light from one or more of the VCSELs 1130 enters the substrate 1134 through the lower surface 1136. Light from one or more of the VCSELs 1130 enters the substrate 1134 through the edge 1137 and is refracted away from the normal. Light emitted from each of the VCSELs 1130 diverges inside the substrate 1134 and is transmitted by the output aperture 1148 so as form at least three beams of light 20 which are emitted along at least three corresponding different emission paths, each emission path extending from the pinhole 1148 along a different corresponding emission direction, wherein each emission direction has a different known orientation relative to an orientation of the sensor area 13 of the image sensor 12. One of ordinary skill in the art will understand that the spatial filter 1132 may also be used with a monolithic VCSEL array like the monolithic VCSEL array 1030′. The spatial filter 1132 may be particularly suitable for use with a monolithic VCSEL array like the monolithic VCSEL array 1030′ because an upper surface of the monolithic VCSEL array 1030′ may be readily aligned, for example brought into engagement with, the lower surface 1136 of the substrate 1134.

Referring now to FIG. 24 there is shown an eighth alternative optical emitter arrangement generally designated 1210 for use in the optical tilt sensor 2. The eighth alternative optical emitter arrangement 1210 includes a plurality of optical emitters in the form of a VCSEL array 1230 and a plurality of micro-lenses 1280, wherein each of the VCSEL elements of the VCSEL array 1230 has a known relative spatial relationship relative to each of the other VCSEL elements of the VCSEL array 1230 and wherein each of the micro-lenses 1280 is aligned relative to a corresponding one of the VCSEL elements of the VCSEL array 1230 so as form at least three beams of light 20 which are emitted along at least three corresponding different emission paths, each emission path extending from a corresponding different known emission position along a different corresponding emission direction, wherein each emission direction has a different known orientation relative to an orientation of the sensor area 13 of the image sensor 12. In this regard, one of ordinary skill in the art will understand that Equation (10) may be readily adapted to account for the different known emission positions of the at least three beams of light 20 to allow the tilt angle of the flat reflective surface 4 to be determined from the measured spacing x₂−x₁ of the peaks or centroids of the intensity peaks formed when the first and second reflected beams 22 are incident on the sensor area 13 of the image sensor 12, and the measured spacing x₃−x₁ of the peaks or centroids of the intensity peaks formed when the first and third reflected beams are incident on the sensor area 13 of the image sensor 12.

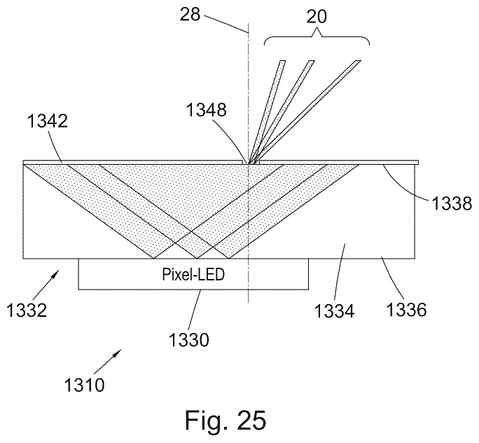

Referring now to FIG. 25 there is shown a ninth alternative optical emitter arrangement generally designated 1310 for use in the optical tilt sensor 2. The ninth alternative optical emitter arrangement 1310 includes a plurality of optical emitters in the form of a pixelated LED 1330 and a corresponding spatial filter 1332 for spatially filtering light emitted by the pixels of the pixelated LED.

The spatial filter 1332 includes a transparent substrate 1334 formed from a glass material which defines a lower input surface 1336 and an upper output surface 1338. The lower input surface 1336 and the upper output surface 1338 are generally parallel. A patterned opaque coating 1342 is formed from a metal such as chrome on the upper or output surface 1338 of the substrate 1334. The patterned opaque coating 1342 on the upper output surface 1338 defines an output aperture 1348 in the form of a pinhole. Each of the pixels of the pixelated LED 1330 has a known relative spatial relationship relative to each of the other pixels of the pixelated LED 1330 and the output pinhole 1348. Each of the pixels of the pixelated LED 1330 is offset horizontally relative to the normal 28 to the output surface 1338 of the substrate 1334 which extends through the pinhole 1348.

Light emitted from each of the pixels of the pixelated LED 1330 travels along a corresponding direction which is generally normal to the lower surface 1336 of the substrate 1134. Light from the pixels of the pixelated LED 1330 enters the substrate 1334 through the lower surface 1336, diverges inside the substrate 1334 and is transmitted by the output aperture 1348 so as form at least three beams of light 20 which are emitted along at least three corresponding different emission paths, each emission path extending from the pinhole 1348 along a different corresponding emission direction, wherein each emission direction has a different known orientation relative to an orientation of the sensor area 13 of the image sensor 12. The pixelated LED 1330 may be particularly suitable for use with the spatial filter 1332 because an upper surface of the pixelated LED 1330 may be readily aligned, for example brought into engagement with, the lower surface 1336 of the substrate 1334 of the spatial filter 1332.

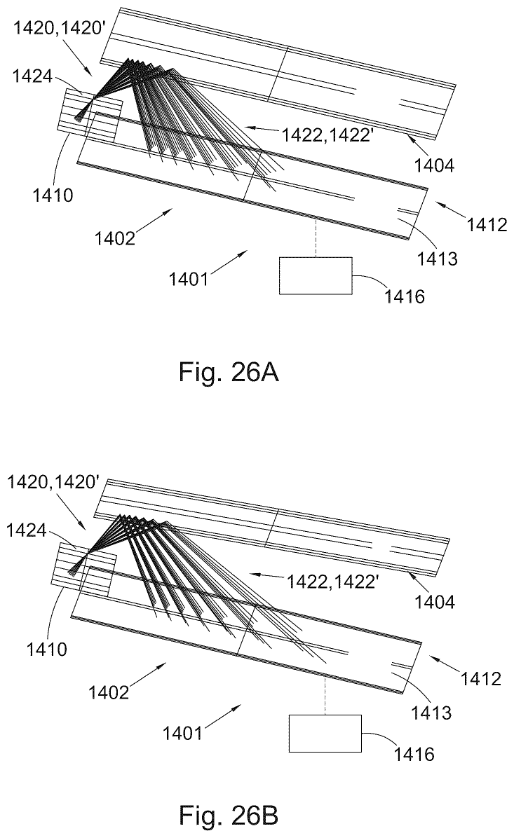

Referring now to FIGS. 26A and 26B, there is shown a 3D optical tilt sensor 1402 in use during measurement of a tilt angle of a flat reflective surface 1404 around a pivot axis (not shown) and a further tilt angle of the flat reflective surface 1404 around a further pivot axis (not shown) which is perpendicular to the pivot axis.

The 3D optical tilt sensor 1402 includes an optical emitter arrangement 1410 and an image sensor 1412 having a sensor area 1413. The optical emitter arrangement 1410 and the image sensor 1412 are fixed relative to one another. The optical tilt sensor 1402 forms part of a tilt measurement apparatus 1401 which includes the optical tilt sensor 1402 and a processing resource 1416. The optical tilt sensor 1402 is configured for communication with processing resource 1416 as indicated by dotted line 1418.

In use, the optical emitter arrangement 1410 emits at least three beams of light 1420 so that each emitted beam of light 1420 is incident on, and reflected from, the flat reflective surface 1404 to form a corresponding reflected beam of light 1422 so that the reflected beams of light 1422 are incident on the sensor area 1413 of the image sensor 1412. The image sensor 1412 detects an intensity distribution of each of the reflected beams of light 1422 and outputs one or more signals representative of the detected intensity distribution of each of the reflected beams of light 1422 to the processing resource 1416. The at least three beams of light 1420 are emitted along at least three corresponding different emission paths, each emission path extending from a common emission point 1424 along a different corresponding emission direction in a plane of incidence, wherein each emission direction has a different known orientation relative to an orientation of the sensor area 1413 of the image sensor 1412. The plane of incidence is perpendicular to the pivot axis.

Similarly, the optical emitter arrangement 1410 emits at least three further beams of light 1420′ so that each emitted further beam of light 1420′ is incident on, and reflected from, the flat reflective surface 1404 to form a corresponding further reflected beam of light 1422′ so that the further reflected beams of light 1422′ are incident on the sensor area 1413 of the image sensor 1412. The image sensor 1412 detects an intensity distribution of each of the further reflected beams of light 1422′ and outputs one or more signals representative of the detected intensity distribution of each of the further reflected beams of light 1422′ to the processing resource 1416. The at least three further beams of light 1420′ are emitted along at least three corresponding different emission paths, each emission path extending from the common emission point 1424 along a different corresponding emission direction in a further plane of incidence, wherein each emission direction has a different known orientation relative to an orientation of the sensor area 1413 of the image sensor 1412. The further plane of incidence is perpendicular to the further pivot axis.

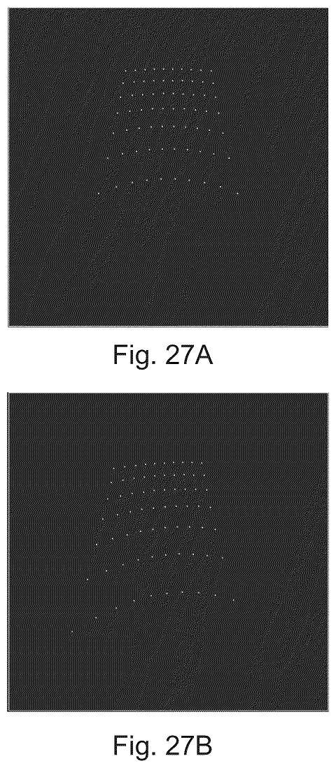

FIG. 27A shows the intensity distribution of each of the reflected beams of light 1422 and each of the further reflected beams of light 1422′ incident on the sensor area 1413 of the image sensor 1412 corresponding to the 3D tilt angle of the flat reflective surface 1404 of FIG. 26A when the flat reflective surface 1404 is parallel to the sensor area 1413 of the image sensor 1412. Similarly, FIG. 27B shows the intensity distribution of each of the reflected beams of light 1422 and each of the further reflected beams of light 1422′ incident on the sensor area 1413 of the image sensor 1412 corresponding to the 3D tilt angle of the flat reflective surface 1404 of FIG. 26B when the flat reflective surface 1404 is titled relative to the sensor area 1413 of the image sensor 1412.

One of ordinary skill in the art will understand that the processing resource 1416 uses the one or more signals representative of the detected intensity distribution of each of the reflected beams of light 1422 and the one or more signals representative of the detected intensity distribution of each of the further reflected beams of light 1422′ to determine the tilt angle of the flat reflective surface 1404 around the pivot axis using a method analogous to any of the methods described above and the further tilt angle of the flat reflective surface 1404 around the further pivot axis using a method analogous to any of the methods described above to thereby determine the 3D tilt of the flat reflective surface 1404. Specifically, the processing resource 1416 uses the separation of the spots of the intensity distributions of each of the reflected beams of light 1422 and each of the further reflected beams of light 1422′ in the horizontal and vertical directions of FIGS. 27A and 27B to thereby determine the 3D tilt of the flat reflective surface 1404 using a method analogous to any of the methods described above.

Although not shown explicitly in FIGS. 26A and 26B, it should also be understood that the optical emitter arrangement 1410 may include an optical emitter in the form of an LED or a laser diode such as a VCSEL and a spatial filter for spatially filtering light emitted by the optical emitter analogous to any of the spatial filters described with reference to any of the foregoing figures so as to generate the at least three beams of light 1420 and the at least three further beams of light 1420′. Additionally or alternatively, the optical emitter arrangement 1410 may include an optical emitter in the form of an LED or a laser diode such as a VCSEL and a DOE for diffracting light emitted by the optical emitter like any one of the DOEs described with reference to FIGS. 20A-20D so as to generate the at least three beams of light 1420 and the at least three further beams of light 1420′. Additionally or alternatively, the optical emitter arrangement 1410 may include a plurality of optical emitters in combination with one or more lenses or a spatial filter so as to generate the at least three beams of light 1420 and the at least three further beams of light 1420′.

Moreover, it should be understood that the 3D optical tilt sensor 1402 may be used as part of an optical 3D tilt control system for orienting a first object 81 and a second object 82 relative to one another in 3D which is analogous to the 2D tilt control system 80 of FIG. 7. Similarly, the 3D optical tilt sensor 1402 may be used as part of an optical 3D tilt control system for orienting a first assembly 91 and a second assembly 92 relative to one another in 3D which is analogous to the 2D tilt control system 90 of FIG. 8.

Although preferred embodiments of the disclosure have been described in terms as set forth above, it should be understood that these embodiments are illustrative only and that the claims are not limited to those embodiments. Those skilled in the art will understand that various modifications may be made to the described embodiments without departing from the scope of the appended claims. For example, the paths of the first, second and third emitted beams 20 may not lie in the same plane. One of the at least three different emission paths and a normal to the sensor area 13 of the image sensor 12 define a plane of incidence. Optionally, each of the other emission paths defines an angle relative to the plane of incidence of less than or equal to 10°, less than or equal to 5°, less than or equal to 2°, or less than or equal to 1° or each of the other emission paths lies in, or lies substantially in, the plane of incidence.

The plane of incidence may not be exactly perpendicular to the pivot axis 6. In general, the optical tilt sensor 2 may be arranged relative to the flat reflective surface 4 so that the plane of incidence has a known orientation relative to the pivot axis 6. For example, the optical tilt sensor 2 may be arranged relative to the flat reflective surface 4 so that a normal to the plane of incidence defines an angle relative to the pivot axis 6 of less than or equal to 10°, less than or equal to 5°, less than or equal to 2°, or less than or equal to 1°.

The spatial filter may define an input aperture and at least three output apertures. Each output aperture may have a known position and orientation relative to each of the other output apertures and the input aperture. The input aperture may be configured to receive light from the optical emitter. Each output aperture may be configured to transmit light received from the input aperture along a corresponding one of the emission paths. The input aperture may be located on an input surface of the spatial filter. Each output aperture may be located on an output surface of the spatial filter. The spatial filter may comprise a transparent substrate having a patterned opaque coating on an input surface of the substrate and a patterned opaque coating on an output surface of the substrate, wherein the input aperture is defined by an aperture in the opaque coating on the input surface of the substrate and each of the at least three output apertures is defined by a corresponding aperture in the opaque coating on the output surface of the substrate. The optical emitter arrangement may comprise a focussing element such as a lens configured to focus light emitted from the optical emitter onto the input aperture.

The optical emitter arrangement may be configured to emit the at least three beams of light simultaneously. The optical emitter arrangement may be configured to emit the at least three beams of light sequentially. The optical emitter arrangement may be configured to emit each of the at least three beams of light for the duration of a corresponding emission period. The different emission periods may at least partially overlap in time.

The optical emitter arrangement may comprise an optical emitter and a reconfigurable, dynamic or programmable beam generator for converting an initial beam of light emitted from the optical emitter so as to define the at least three emitted beams of light. The beam generator may comprise a spatial light modulator (SLM) such as an SLM which comprises, or is formed from, a liquid crystal material, or a digital micromirror device (DMD).

In the spatial emitter arrangement 710 shown in FIG. 18A, the spatial filter 732 may define a DOE on the upper surface 738 of the transparent substrate 734. The DOE may be defined in addition to the output aperture 748. For example, the DOE may be defined in the output aperture 748. The DOE may be defined as an alternative to the output aperture 748. In use, the DOE may receive at a least a portion of the divergent light emitted by the optical emitter 730.

Each feature disclosed or illustrated in the present specification may be incorporated in any embodiment, either alone, or in any appropriate combination with any other feature disclosed or illustrated herein. In particular, one of ordinary skill in the art will understand that one or more of the features of the embodiments of the present disclosure described above with reference to the drawings may produce effects or provide advantages when used in isolation from one or more of the other features of the embodiments of the present disclosure and that different combinations of the features are possible other than the specific combinations of the features of the embodiments of the present disclosure described above.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Use of the term “comprising” when used in relation to a feature of an embodiment of the present disclosure does not exclude other features or steps. Use of the term “a” or “an” when used in relation to a feature of an embodiment of the present disclosure does not exclude the possibility that the embodiment may include a plurality of such features.

The use of reference signs in the claims should not be construed as limiting the scope of the claims.

### LIST OF REFERENCE NUMERALS

1 tilt measurement apparatus;
2 optical tilt sensor;
3 PCB;
4 flat reflective surface;
6 pivot axis;
10 optical emitter arrangement;
12 image sensor;
13 sensor area of the image sensor;
14 housing;
16 processing resource;
18 communication link between the image sensor and the processing resource;
20 beams of light emitted from optical emitter arrangement;
22 beams of light reflected from the flat reflective surface;
24 common emission point;
26 intensity distributions of reflected beams of light on sensor area of image sensor;
28 normal to sensor area of image sensor;
30 optical emitter;
32 spatial filter;
34 transparent substrate;
36 input surface of transparent substrate;
38 output surface of transparent substrate;
40 patterned opaque coating on input surface of transparent substrate;
42 patterned opaque coating on output surface of transparent substrate;
46 input apertures of spatial filter;
48 output aperture of spatial filter;
80 optical tilt control system;
81 first object;
82 second object;
84 flat reflective probe surface of second object;
86 tilt actuator;
88 PCB;
90 optical tilt control system;
91 first assembly;
91a first optical component of first assembly;
91b base member of first assembly;
910 second optical component of first assembly;
91d flat reflective surface of first assembly;
92 second assembly;
92a first optical component of second assembly;
92b base member of second assembly;
920 second optical component of second assembly;
96 tilt actuator;
132 spatial filter;
134 transparent substrate;
136 input surface of transparent substrate;
138 output surface of transparent substrate;
140 patterned opaque coating on input surface of transparent substrate;
142 patterned opaque coating on output surface of transparent substrate;
146 input apertures of spatial filter;
148 output aperture of spatial filter;
150 layer of UV-cured material;
152 layer of UV-cured material;
232 spatial filter;
234 transparent substrate;
236 input surface of transparent substrate;
238 output surface of transparent substrate;
240 patterned opaque coating on input surface of transparent substrate;
242 patterned opaque coating on output surface of transparent substrate;
246 input apertures of spatial filter;
248 output aperture of spatial filter;
250 layer of UV-cured material;
252 layer of UV-cured material;
254 input micro-prism;
256 output micro-prism;
332 spatial filter;
334 transparent substrate;
336 input surface of transparent substrate;
338 output surface of transparent substrate;
340 patterned opaque coating on input surface of transparent substrate;
342 patterned opaque coating on output surface of transparent substrate;
346 input apertures of spatial filter;
348 output aperture of spatial filter;
350 layer of UV-cured material;
352 layer of UV-cured material;
354 input micro-prism;
356 output micro-lens;
432 spatial filter;
434 transparent substrate;
446 input apertures of spatial filter;
448 output aperture of spatial filter;
454 input micro-lens;
456 output micro-lens;
532 spatial filter;
534 transparent substrate;
546 input apertures of spatial filter;
548 output aperture of spatial filter;
554 input micro-lens;
556 output micro-prism;
610 optical emitter arrangement;
630 structured LED optical emitter;
632 spatial filter;
648 output aperture of spatial filter;
660 aperture or window of structured LED;
661 LED;
662 die;
664 light emitting surface of die;
666 opaque coating;
668 beam of light emitted from aperture or window of structured LED;
710 optical emitter arrangement;
730 optical emitter;
734 transparent substrate;
736 input surface of transparent substrate;
738 output surface of transparent substrate;
742 patterned opaque coating on output surface of transparent substrate;
748 output aperture of spatial filter;
810 optical emitter arrangement;
830 optical emitter;
834 transparent substrate;
836 lower surface of transparent substrate;
837 edge of transparent substrate;
838 upper output surface of transparent substrate;
842 patterned opaque coating on output surface of transparent substrate;
848 output aperture of spatial filter;
910 optical emitter arrangement;
930 optical emitter;
970 diffractive optical element;
1010 optical emitter arrangement;
1030 plurality of discrete optical emitters;
1074 lens;
1030′ monolithic VCSEL array;
1110 optical emitter arrangement;
1130 plurality of optical emitters;
1134 transparent substrate;
1136 lower surface of transparent substrate;
1137 edge of transparent substrate;
1138 upper output surface of transparent substrate;
1142 patterned opaque coating on output surface of transparent substrate;
1148 output aperture of spatial filter;
1210 optical emitter arrangement;
1230 monolithic VCSEL array;
1280 micro-lenses;
1310 optical emitter arrangement;
1330 pixelated LED
1334 transparent substrate;
1336 lower input surface of transparent substrate;
1338 upper output surface of transparent substrate;
1342 patterned opaque coating on output surface of transparent substrate;
1348 output aperture of spatial filter;
1401 tilt measurement apparatus;
1402 optical tilt sensor;
1404 flat reflective surface;
1410 optical emitter arrangement;
1412 image sensor;
1413 sensor area of the image sensor;
1416 processing resource;
1420, 1420′ beams of light emitted from optical emitter arrangement;
1422, 1422′ beams of light reflected from the flat reflective surface;
1424 common emission point;

1. An optical tilt measurement apparatus for use in measuring a tilt angle of a flat reflective surface around a pivot axis, the optical tilt measurement apparatus comprising:
an optical tilt sensor for use in sensing a tilt angle of a flat reflective surface around a pivot axis, the optical tilt sensor comprising:
an optical emitter arrangement for emitting at least three beams of light so that each emitted beam of light is incident on, and reflected from, the flat reflective surface to form a corresponding reflected beam of light; and
an image sensor having a sensor area for detecting an intensity distribution of each of the reflected beams of light and outputting one or more signals representative of the detected intensity distribution of each of the reflected beams of light,
wherein the at least three emitted beams of light are emitted along at least three corresponding different emission paths, each emission path extending from a corresponding emission point along a corresponding different emission direction,
wherein each emission direction has a different known orientation relative to an orientation of the sensor area of the image sensor,
wherein each emission point has a known spatial relationship relative to each of the other emission points, and points,
wherein the optical tilt sensor is arranged relative to the flat reflective surface so that each emission direction defines a corresponding known angle relative to the pivot axis, and
wherein the optical tilt measurement apparatus further comprises a processing resource configured to:
receive the one or more output signals from the image sensor;
determine, from the one or more received output signals, a position of each of at least three intensity peaks on the sensor area of the image sensor, each intensity peak corresponding to the peak intensity of a corresponding one of the reflected beams of light when incident on the sensor area of the image sensor;
determine a spacing of a first pair of the at least three intensity peaks on the sensor area of the image sensor;
determine a spacing of a second pair of the at least three intensity peaks on the sensor area of the image sensor; and
determine the tilt angle of the flat reflective surface around the pivot axis based at least in part on the different known orientations of the different emission directions relative to the orientation of the sensor area of the image sensor, the known relative spatial relationship between the emission points, the different known angle of each emission direction relative to the pivot axis, and the determined spacing of the first pair of intensity peaks and the determined spacing of the second pair of intensity peaks.

2. The optical tilt measurement apparatus according to claim 1, wherein the flat reflective surface is planar or generally planar and/or wherein the flat reflective surface constitutes a flat reflective area of a larger generally non-planar surface, wherein the flat reflective area is planar or generally planar.

3. The optical tilt measurement apparatus according to claim 1, wherein at least one of:
two or more of the emission points are the same;
all of the emission points are the same;
two or more of the emission points are different; or
all of the emission points are different.

4. The optical tilt measurement apparatus according to claim 1, wherein at least one of:
the optical emitter arrangement is configured to emit the at least three beams of light simultaneously;
the optical emitter arrangement is configured to emit the at least three beams of light sequentially; or
the optical emitter arrangement is configured to emit each of the at least three beams of light for the duration of a corresponding emission period and the different emission periods at least partially overlap in time.

5. The optical tilt measurement apparatus according to claim 1, wherein the optical emitter arrangement comprises an optical emitter comprising an LED or a laser.

6. The optical tilt measurement apparatus according to claim 5, wherein the optical emitter arrangement comprises a spatial filter for spatially filtering light emitted from the optical emitter so as to at least partially define the at least three emitted beams of light and optionally wherein:
the spatial filter defines at least three input apertures and an output aperture,
each input aperture has a known position and orientation relative to each of the other input apertures and the output aperture,
each input aperture is configured to receive light from the optical emitter, and
the output aperture is configured to transmit light received from each input aperture along a corresponding one of the emission paths.

7. The optical tilt measurement apparatus according to claim 6, wherein at least one of:
each of the input apertures is offset relative to a normal to the output surface of the spatial filter which extends through the output aperture;
the optical emitter arrangement comprises a focussing element comprising a lens configured to focus light emitted from the optical emitter (30) onto the output aperture; or
the spatial filter comprises one or more optical micro-structures or micro-optical components comprising one or more micro-lenses or one or more micro-prisms and wherein each of the one or more optical micro-structures or micro-optical components is on or over a corresponding aperture defined by the spatial filter.

8. The optical tilt measurement apparatus according to claim 5, wherein the optical emitter arrangement comprises a diffractive optical element for diffracting an initial beam of light emitted from the optical emitter so as to define the at least three emitted beams of light.

9. The optical tilt measurement apparatus according to claim 5, wherein the optical emitter arrangement comprises a reconfigurable, dynamic or programmable beam generator comprising a spatial light modulator or a digital micromirror device for converting an initial beam of light emitted from the optical emitter so as to define the at least three emitted beams of light.

10. The optical tilt measurement apparatus according to claim 5, wherein the optical emitter comprises a patterned opaque coating formed directly on a light emitting surface of the optical emitter so as to define at least three light emitting apertures, wherein each light emitting aperture has a known spatial relationship relative to each of the other light emitting apertures and, optionally, wherein the optical emitter arrangement comprises a spatial filter for spatially filtering light emitted from each light emitting aperture of the optical emitter.

11. The optical tilt measurement apparatus according to claim 1, wherein the optical emitter arrangement comprises at least three optical emitters, wherein the at least three optical emitters have a known position and orientation relative to one another, and wherein at least one of the optical emitters in the optical emitter arrangement comprises an LED array, a pixelated LED, a laser.

12. The optical tilt measurement apparatus according to claim 11, comprising a focussing element comprising a lens having a known spatial relationship relative to the at least three optical emitters, wherein the lens directs, focusses and/or collimates light emitted by each optical emitter of the at least three optical emitters so as to define the at least three emitted beams of light, or comprising at least three micro-lenses, wherein each micro-lens has a known configuration and a known position and orientation relative to a corresponding optical emitter of the at least three optical emitters so as to define the at least three emitted beams of light.

13. The optical tilt measurement apparatus according to claim 11, comprising a spatial filter having a known configuration and a known position and orientation relative to the at least three optical emitters so as to spatially filter light emitted by each optical emitter of the at least three optical emitters so as to define the at least three emitted beams of light, wherein the spatial filter defines an aperture, wherein the aperture has a known position and orientation relative to the at least three optical emitters, and wherein the aperture is configured to transmit light emitted by the at least three optical emitters along the at least three emission directions.

14-16. (canceled)

17. An optical tilt control system for use in controlling a tilt angle of a flat reflective surface, and any one or more objects or assemblies connected to the flat reflective surface, around a pivot axis, the optical tilt control system comprising:
the optical tilt measurement apparatus as claimed in claim 1; and
a tilt actuator for adjusting the tilt angle of the flat reflective surface, and any one or more objects or assemblies connected to the flat reflective surface, around the pivot axis,
wherein the processing resource is configured to control the tilt actuator so as to control the tilt angle of the flat reflective surface, and any one or more objects or assemblies connected to the flat reflective surface, based on the determined tilt angle of the flat reflective surface.

18. A method for use in measuring a tilt angle of a flat reflective surface around a pivot axis, the method comprising:
emitting at least three beams of light so that each emitted beam of light is incident on, and reflected from, the flat reflective surface to form a corresponding reflected beam of light; and
detecting an intensity distribution of each of the reflected beams of light on a sensor area of an image sensor and outputting one or more signals representative of the detected intensity distribution of each of the reflected beams of light from the image sensor,
wherein the at least three emitted beams of light are emitted along at least three corresponding different emission paths, each emission path extending from a corresponding emission point along a different corresponding emission direction,
wherein each emission direction has a different known orientation relative to an orientation of the sensor area of the image sensor and each emission point has a known spatial relationship relative to each of the other emission points, and
wherein the method further comprises:
determining, from the one or more received output signals, a position of each of at least three intensity peaks on the sensor area of the image sensor, each intensity peak corresponding to the peak intensity of a corresponding one of the reflected beams of light when incident on the sensor area of the image sensor;
determining a spacing of a first pair of the at least three intensity peaks on the sensor area of the image sensor;
determining a spacing of a second pair of the at least three intensity peaks on the sensor area of the image sensor; and
determining the tilt angle of the flat reflective surface around the pivot axis based at least in part on the one or more output signals, the different known orientations of the different emission directions relative to the orientation of the sensor area of the image sensor, the known relative spatial relationship between the emission points, a known orientation of each emission direction relative to the pivot axis, and the determined spacing of the first pair of intensity peaks and the determined spacing of the second pair of intensity peaks.

19-20. (canceled)

21. A method for use in measuring a change in a tilt angle of a flat reflective surface around a pivot axis, the method comprising:
determining a first tilt angle of the flat reflective surface around the pivot axis based at least in part on the one or more output signals generated according to the method of claim 18 when the flat reflective surface is tilted around the pivot axis at the first tilt angle;
determining a second tilt angle of the flat reflective surface around the pivot axis based at least in part on the one or more output signals generated according to the method of claim 18 when the flat reflective surface is tilted around the pivot axis at the second tilt angle; and
determining a change between the first and second tilt angles of the flat reflective surface around the pivot axis, wherein the change is a difference between the first and second tilt angles, a percentage change between the first and second tilt angles, or a ratio of the first and second tilt angles.

22. A method for use in controlling a tilt angle of a flat reflective surface, and any one or more objects or assemblies connected to the flat reflective surface, around a pivot axis, the method comprising:
the method for use in measuring the tilt angle of the flat reflective surface around the pivot axis according to claim 18, wherein the method further comprises:
controlling the tilt angle of the flat reflective surface, and any one or more objects or assemblies connected to the flat reflective surface, based on the determined tilt angle of the flat reflective surface.

23. A method for use in orienting first and second objects relative to one another, the method comprising:
mounting the optical tilt sensor of the optical tilt measurement apparatus as claimed in claim 1 on a surface of a base member;
mounting the first object on the surface of the base member;
arranging the second object relative to the optical tilt sensor so that each emitted beam of light is incident on, and reflected from, a flat reflective surface of the second object to form the corresponding reflected beam of light, so that the sensor area of the image sensor detects an intensity distribution of each of the reflected beams of light and outputs one or more signals representative of the detected intensity distribution of each of the reflected beams of light, and so that each emission direction has a different known orientation relative to the pivot axis;
determining a tilt angle of the flat reflective surface of the second object around the pivot axis based at least in part on the one or more output signals, the different known orientations of the different emission directions relative to the orientation of the sensor area of the image sensor, the known relative spatial relationship between the emission points, and a known orientation of each emission direction relative to the pivot axis; and
controlling the relative orientation of the first and second objects according to the determined tilt angle of the flat reflective surface of the second object.

24. A method for use in controlling a tilt angle of a flat reflective surface, and any one or more objects or assemblies connected to the flat reflective surface, around a pivot axis, the method comprising:
the method for use in measuring the tilt angle of the flat reflective surface around the pivot axis according to claim 21, wherein the method further comprises:
controlling the tilt angle of the flat reflective surface, and any one or more objects or assemblies connected to the flat reflective surface, based on the determined change between the first and second tilt angles of the flat reflective surface around the pivot axis.
